(19) United States
(12) Patent Application Publication
(10) Pub. No.: US 2026/0006665 A1
(43) Pub. Date: Jan. 1, 2026

(54) ELECTRONIC DEVICE FOR PERFORMING SCHEDULING OF A PLURALITY OF LINKS AND METHOD FOR THE SAME

(71) Applicant: Samsung Electronics Co., Ltd., Suwon-si (KR)

(72) Inventors: Hyunkee MIN, Suwon-si (KR); Junsung KIM, Suwon-si (KR); Soonho LEE, Suwon-si (KR); Junghwi JEON, Suwon-si (KR); Buseop JUNG, Suwon-si (KR); Minsik HWANG, Suwon-si (KR)

(21) Appl. No.: 19/302,884

(22) Filed: Aug. 18, 2025

Related U.S. Application Data
(63) Continuation of application No. PCT/KR2025/009376, filed on Jul. 1, 2025.

(30) Foreign Application Priority Data
Jul. 1, 2024 (KR) 10-2024-0086379
Aug. 30, 2024 (KR) 10-2024-0117572

(51) Int. Cl. H04W 76/15; H04W 72/044; H04W 72/1263; H04W 84/18

(52) U.S. Cl. CPC H04W 76/15; H04W 72/044; H04W 72/1263; H04W 84/18

(57) ABSTRACT

An electronic device may include communication circuitry supporting a plurality of short-range wireless communications, including a first short-range wireless communication and a second short-range wireless communication. The electronic device may include a memory storing at least one computer program, and at least one processor. The at least one computer program may include instructions that, when executed by the at least one processor, individually or collectively, cause the electronic device to detect activation of the second short-range wireless communication while performing the first short-range wireless communication using a first link corresponding to a first frequency band and a second link corresponding to a second frequency band higher than the first frequency band. The instructions may cause the electronic device to perform scheduling of the first link and the second link, based on a first throughput of data transmitted/received through the first short-range wireless communication and a second throughput of data to be transmitted/received through the second short-range wireless communication. The instructions may cause the electronic device to perform, based on the scheduling, the first short-range wireless communication using the first link and the second short-range wireless communication using the second link during a first time, and the first short-range wireless communication using the second link and the second short-range wireless communication using the first link during a second time.

### CROSS-REFERENCE TO RELATED APPLICATIONS

This application is a continuation application of International Application No. PCT/KR2025/009376 designating the United States, filed on Jul. 1, 2025, in the Korean Intellectual Property Receiving Office and claiming priority to Korean Patent Application No. 10-2024-0086379, filed on Jul. 1, 2024, and Korean Patent Application No. 10-2024-0117572, filed on Aug. 30, 2024, the disclosures of which are all hereby incorporated by reference herein in their entireties.

### BACKGROUND

### Technical Field

Certain example embodiments may relate to an electronic device and/or a method of operating the electronic device, and for example to an electronic device that performs scheduling of a plurality of links.

### Background Art

With the spread of various electronic devices, the speed of wireless communication that can be used by various electronic devices has been improved. Among the wireless communications supported by recent electronic devices, IEEE 802.11 WLAN (or, Wi-Fi) is a standard for implementing high-speed wireless connections on various electronic devices. The first implemented Wi-Fi could support a transmission speed of up to 1 to 9 Mbps, but Wi-Fi 6 technology (or, IEEE 802.11 ax) can support transmission speeds of up to about 10 Gbps.

The electronic device may support various services (e.g., UHD quality video streaming services, augmented reality (AR) services, virtual reality (VR) services, or mixed reality (MR) services) utilizing relatively large amounts of data through wireless communications supporting high transmission rates.

The IEEE 802.11 WLAN standard will introduce technologies that support multi-link operation (MLO) to improve speed and reduce the latency of data transmission and reception. Electronic devices that support multi-link operation are expected to realize relatively high transmission rate and low latency because they can transmit and receive data through a plurality of links.

An electronic device may perform various short-range wireless communications (e.g., Wi-Fi, Wi-Fi direct, neighbor awareness networking (NAN), soft AP) simultaneously in order to perform various services simultaneously. The electronic device may perform various short-range wireless communications through a plurality of links.

### SUMMARY

An electronic device may perform various short-range wireless communications (e.g., Wi-Fi, Wi-Fi direct, neighbor awareness networking (NAN), soft AP) simultaneously in order to perform various services simultaneously. The electronic device may perform various short-range wireless communications through a plurality of links.

As the number of activated short-range wireless communications increases, the electronic device must appropriately perform scheduling of a plurality of links. However, in the case that the electronic device fails to appropriately perform scheduling, the electronic device may not be able to perform data transmission and/or reception using other short-range wireless communications because of link occupancy caused by data transmission and/or reception using some short-range wireless communications, and the quality of services using other short-range wireless communications may deteriorate.

Example technical problems to be achieved in the present document are not limited to the technical problems mentioned above, and other technical problems not mentioned will be clearly understood by a person having ordinary skill in the technical field from the description below.

An example electronic device may include communication circuitry supporting a plurality of short-range wireless communications, including a first short-range wireless communication and a second short-range wireless communication. The electronic device may include a memory storing at least one computer program. The electronic device may include at least one processor comprising processing circuitry. The at least one computer program may include instructions that, when executed by the at least one processor, individually or collectively, cause the electronic device to detect activation of the second short-range wireless communication while performing the first short-range wireless communication using a first link corresponding to a first frequency band and a second link corresponding to a second frequency band higher than the first frequency band. The instructions may cause the electronic device to perform scheduling of the first link and the second link, based on a first throughput of data transmitted/received through the first short-range wireless communication and a second throughput of data to be transmitted/received through the second short-range wireless communication. The instructions may cause the electronic device to perform, based on the scheduling, the first short-range wireless communication using the first link and the second short-range wireless communication using the second link during a first time, and to perform the first short-range wireless communication using the second link and the second short-range wireless communication using the first link during a second time.

In a computer-readable recording medium that stores instructions to be executed by the electronic device's processor(s), according to an example, the instructions may cause the electronic device to detect activation of a second short-range wireless communication while performing a first short-range wireless communication using a first link corresponding to a first frequency band and a second link corresponding to a second frequency band higher than the first frequency band. The instructions may cause the electronic device to perform scheduling of the first link and the second link, based on a first throughput of data transmitted/received through the first short-range wireless communication and a second throughput of data to be transmitted/received through the second short-range wireless communication. The instructions may cause the electronic device to perform, based on the scheduling, the first short-range wireless communication using the first link and the second short-range wireless communication using the second link during a first time, and perform the first short-range wireless communication using the second link and the second short-range wireless communication using the first link during a second time.

The method of operating the electronic device according to an example may include detecting activation of the second short-range wireless communication while performing the first short-range wireless communication using the first link corresponding to the first frequency band and the second link corresponding to a second frequency band higher than the first frequency band. The method of operating the electronic device may include performing scheduling of the first link and the second link, based on a first throughput of data transmitted/received through the first short-range wireless communication and a second throughput of data to be transmitted/received through the second short-range wireless communication. The method of operating the electronic device may include, based on the scheduling, performing the first short-range wireless communication using the first link and the second short-range wireless communication using the second link during a first time, and performing the first short-range wireless communication using the second link and the second short-range wireless communication using the first link during a second time.

The electronic device, according to an example, may include communication circuitry supporting a plurality of short-range wireless communication protocols, including a first wireless communication protocol and a second wireless communication protocol. The electronic device may include at least one processor comprising processing circuitry. The at least one processor may receive, through the wireless communication circuitry, a request related to a second short-range wireless communication corresponding to the second short-range wireless communication protocol from a second external device different from the first external device while a first short-range wireless communication corresponding to the first short-range wireless communication protocol is being performed for the first external device through a first link corresponding to a first frequency band and a second link corresponding to a second frequency band. The processor may, based at least in part on the request, be configured to control the wireless communication circuitry to cause the second short-range wireless communication to be performed for the second external device through the second link while the first short-range wireless communication is not performed through the second link and is performed for the first external device through the first link, or to cause the second short-range wireless communication to be performed for the second external device through the second link and the first link in the first time period and the second time period, respectively, while the first short-range wireless communication is performed through the first link in the first time period and is performed through the second link in the second time period different from the first time period.

An electronic device, according to an example, may include a wireless communication circuitry supporting a plurality of short-range wireless communication protocols, including a first wireless communication protocol and a second wireless communication protocol. The electronic device may include a processor comprising processing circuitry. The processor may receive, through the wireless communication circuitry, a request from a third external device related to a third short-range wireless communication while the first short-range wireless communication and the second short-range wireless communication corresponding to the first short-range wireless communication protocol and the second short-range wireless communication protocol, respectively, are being performed simultaneously for the first external device and the second external device through a first link corresponding to a first frequency band and a second link corresponding to a second frequency band. The processor may, based at least in part on the request, be configured to control the wireless communication circuitry to cause the second short-range wireless communication and the third short-range wireless communication to be performed through the second link for the second external device and the third external device, respectively, in the first time period and the second time period, which are different each other, while the first short-range wireless communication is not performed through the second link and is performed through the first link for the first external device.

An electronic device and an operating method of the electronic device, according to one embodiment, may perform scheduling of a first link and a second link based on a throughput of data transmitted/received through the first short-range wireless communication and a throughput of data transmitted/received through the second short-range wireless communication by activating a second short-range wireless communication while activating a first short-range wireless communication. The electronic device may, based on the scheduling, perform the first short-range wireless communication using the first link and the second short-range wireless communication using the second link during a first time and perform the first short-range wireless communication using the second link and the second short-range wireless communication using the first link during a second time. The electronic device may perform scheduling to continuously perform each of the short-range wireless communications, by changing the links utilized by each of the short-range wireless communications, to improve the quality of the short-range wireless communications and/or the quality of the service utilizing each of the short-range wireless communications.

An electronic device and a method of operating the electronic device, according to an embodiment, may configure a first time length and a second time length based on a throughput of data transmitted/received through the first short-range wireless communication and a throughput of data transmitted/received through the second short-range wireless communication. The electronic device may improve the quality of the short-range wireless communication requiring a high throughput by configuring the first time length and the second time length so that the short-range wireless communication requiring a high throughput occupies more of the second link having a higher frequency band.

The effects obtainable are not limited to the effects mentioned above, and other effects not mentioned will be clearly understood by a person skilled in the art to which the present disclosure belongs from the description below.

### BRIEF DESCRIPTION OF DRAWINGS

FIG. 1 is a block diagram of an electronic device according to an example embodiment.

FIG. 2 is a diagram illustrating an embodiment in which an electronic device operates in MLO (multi-link operation) according to an example embodiment.

FIG. 3 is a diagram illustrating an electronic device, according to an example embodiment, performing a plurality of short-range wireless communications through a first link, a second link, and/or a third link.

FIG. 4 is a block diagram of an electronic device according to an example embodiment.

FIG. 5A is a diagram illustrating an example schedule of a first link and a second link configured by an electronic device according to an example embodiment.

FIG. 5B is a diagram illustrating an example schedule of a first link and a second link configured by an electronic device according to an example embodiment.

FIG. 5C is a diagram illustrating an example schedule of a first link and a second link configured by an electronic device according to an example embodiment.

FIG. 5D is a diagram illustrating an example schedule of a first link and a second link configured by an electronic device according to an example embodiment.

FIG. 6A is a diagram illustrating an example schedule of a first link and a second link configured by an electronic device according to an example embodiment.

FIG. 6B is a diagram illustrating an example schedule of a first link and a second link configured by an electronic device according to an example embodiment.

FIG. 7 is a flowchart illustrating an operating method of an electronic device according to an example embodiment.

FIG. 8 is a flowchart illustrating an operating method of an electronic device according to an example embodiment.

FIG. 9 is a flowchart illustrating an operating method of an electronic device according to an example embodiment.

### DETAILED DESCRIPTION

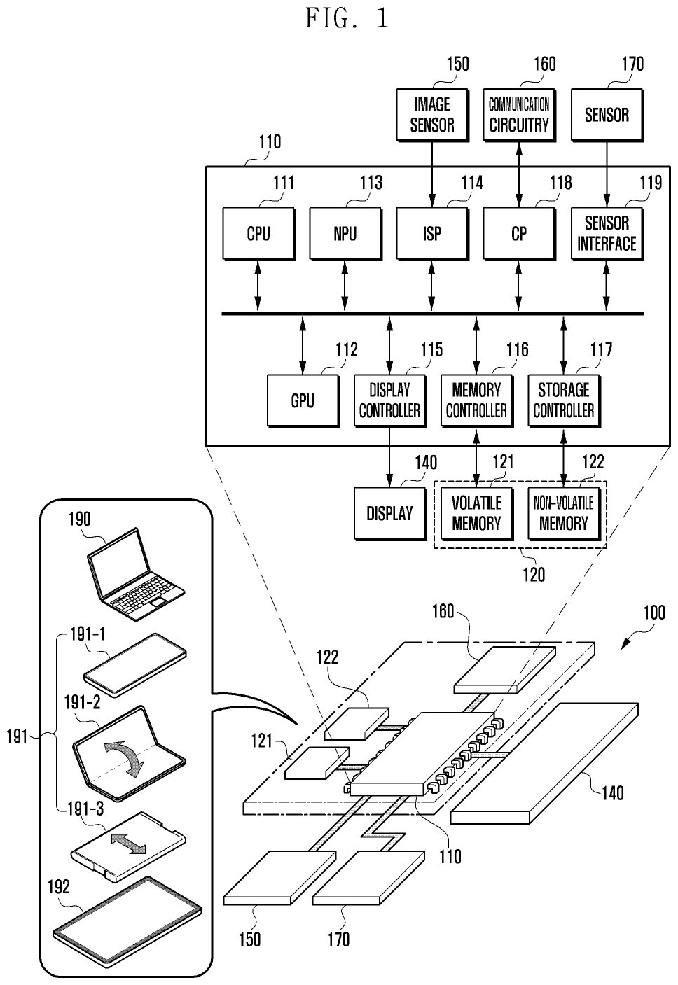

FIG. 1 illustrates a block diagram of an exemplary electronic device 100 capable of performing the operations described herein.

With reference to FIG. 1, the electronic device 100 may be one of various types of electronic devices, such as a notebook computer 190, smartphones 191 having various form factors (e.g., a bar-type smartphone 191-1, a foldable smartphone 191-2, or a slidable (or rollable) smartphone 191-3), a tablet PC 192, a cellular telephone (not shown), and any other similar computing devices (not shown). The components illustrated in FIG. 1, the relationships thereof, and the functions thereof are merely for illustration, and are not intended to limit the implementations described or claimed in the disclosure thereto. The electronic device 100 may be referred to as a mobile device, a user equipment, a multifunctional device, a portable device, or a server.

The electronic device 100 may comprise various components including at least one processor 110 (hereinafter, the processor 110), at least one memory 120 (hereinafter, the memory 120), at least one display 140 (hereinafter, the display 140), at least one image sensor 150 (hereinafter, the image sensor 150), at least one communication circuitry 160 (hereinafter, the communication circuitry 160), and/or at least one sensor 170 (hereinafter, the sensor 170). The aforementioned components are merely of an example. For example, the electronic device 100 may comprise other components (e.g., a power management integrated circuitry (PMIC), an audio processing circuitry, an antenna, a rechargeable battery, or an input/output interface). For example, some components may be omitted from the electronic device (100). For example, some components may be integrated into one component.

The processor 110 may be implemented as one or more integrated circuit (or circuitry) (IC) chips and may perform various data processing. The processor 110 may include at least one electrical circuitry and may process instructions (or program, data, and so on) stored in the memory 120 individually or collectively in a distributed manner. The processor 110 may include a processor assembly that includes one or more processing circuitries. The processor may include any processing circuitry that may be operative for controlling operations and performance of one or more components (e.g., the memory 120, a display 140, the image sensor 150, the communication circuitry 160, and/or the sensor 170) of the electronic device. For example, the processor 110 (e.g., an application processor (AP)) may be implemented as a system on chip (SoC) (e.g., one chip or chipset). For example, the processor 110 may be implemented as a plurality of cores (or at least one core circuitry), a plurality of chips, or a plurality of chipsets. For example, the processor 110 may comprise one or more processing circuitry. For example, the processor 110 may comprise one or more processing circuitry which are individually and/or collectively configured to perform various functions of the present disclosure. As a non-limiting example, at least a portion of the processor 110 may be included in a first chip of the electronic device 100 and at least another portion of the processor 110 may be included in a second chip of the electronic device 100 different from the first chip of the electronic device 100.

For example, the processor 110 may comprise a central processing unit (CPU) 111, a graphics processing unit (GPU) 112, a neural processing unit (NPU) 113, an image signal processor (ISP) 114, a display controller 115, a memory controller 116, a storage controller 117, a communication processor (CP) 118, and/or a sensor interface 119. These components of the processor 110 are merely of an example. For example, the processor 110 may further comprise other components. For example, some components of the processor 110 may be omitted from the processor 110. For example, some components of the processor 110 may be included as separate components of the electronic device 100 outside the processor 110. For example, some components of the processor 110 (e.g., the memory controller 116) may be included in other components of the electronic device 100 (e.g., at least a portion of the memory 120, an interface (e.g., usable for connecting to at least one component of the electronic device 100), the display 140, and/or the image sensor 150).

The processor 110 may cause other components of the electronic device 100 to perform various operations by executing instructions stored in the memory 120. The CPU 111 (or a central processing circuitry) may be configured to control the components of the processor 110 based on execution of instructions stored in the memory 120 (e.g., the volatile memory 121 and/or the non-volatile memory 122). The GPU 112 (or a graphic processing circuitry) may be configured to execute parallel computations (e.g., rendering). The NPU 113 (or a neural processing circuitry, or an artificial intelligence (AI) chip) may be configured to execute operations (e.g., convolution computations) for an artificial intelligence model. The ISP 114 (or an image signal processing circuitry) may be configured to process a raw image obtained from the image sensor 150 in a format suitable for a component in the electronic device 100 or a component of the processor 110. The display controller 115 (or a display control circuitry, or a display processing unit (DPU)) may be configured to process an image obtained from the CPU 111, the GPU 112, the ISP 114, or the memory 120 (e.g., the volatile memory 121) in a format suitable for the display 140. The memory controller 116 (or a memory control circuitry) may be configured to control reading data from the volatile memory 121 and writing data to the volatile memory 121. The storage controller 117 (or a storage control circuitry) may be configured to control reading data from the non-volatile memory 122 and writing data to the non-volatile memory 122. The CP 118 (or a communication processing circuitry) may be configured to process data obtained from a component of the processor 110 in a format suitable for transmission to another electronic device through the communication circuitry 160, or to process data obtained from another electronic device through the communication circuitry 160 in a format suitable for processing of the component of the processor 110. For example, the communication circuitry 160 may comprise one or more communication circuitry. The sensor interface 119 (or a sensing data processing circuitry, a sensor hub) may be configured to process data on a state of the electronic device 100 and/or a state around the electronic device 100, obtained through the sensor 170, in a format suitable for a component of the processor 110.

The memory 120 may comprise one or more storage mediums (or one or more storage devices). For example, the memory 120 may include a memory assembly that includes one or more storage mediums. For example, the one or more storage mediums may comprise a permanent memory (e.g., the non-volatile memory 122) such as a hard drive, a flash memory, a read-only memory (ROM), a semi-permanent memory (e.g., the volatile memory 121) such as a random access memory (RAM), a storage (or a storage assembly) of any other suitable type, or any combination thereof. The memory 120 may comprise a cache memory which is a memory of one or more different types used to store data for performing a function or feature of the electronic device 100 at least temporarily. As a non-limiting example, the cache memory may be included in the processor 110. The memory 120 may be fixedly embedded within the electronic device 100, or may be incorporated onto one or more suitable types of components that may be repeatedly inserted into the electronic device 100, and removed from the electronic device 100 (e.g., a subscriber identity module (SIM) card, and/or a secure digital (SD) card).

For example, the memory 120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 110. For example, the memory 120 may store instructions callable by an application programming interface (API). For example, the memory 120 may store instructions in a library.

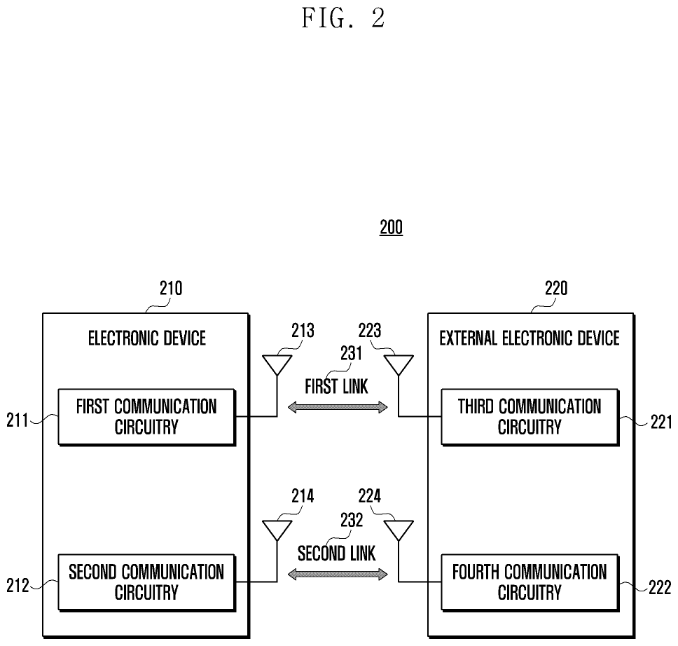

FIG. 2 is a diagram illustrating an example in which an electronic device and an access point (AP) operate in MLO (multi-link operation) according to an example embodiment.

With reference to FIG. 2, the wireless LAN system 200 may include an electronic device 210 and/or an external electronic device 220. According to an example embodiment, the electronic device 210 may perform short-range wireless communication with the external electronic device 220. Short-range wireless communication may refer to various communication methods that both the electronic device 210 and/or the external electronic device 220 may support. For example, the short-range wireless communication may be Wi-Fi. The external electronic device 220 may function as a base station that provides short-range wireless communication to at least one electronic device 210 located within a communication radius of the wireless LAN system 200. For example, the external electronic device 220 may include an access point (AP) of IEEE 802.11. The electronic device 210 may include a station (STA) of IEEE 802.11.

The Wi-Fi of the electronic device 210 may have a separate Wi-Fi network interface on the host processor for controlling operation in a wireless local area network (LAN) chipset. This may include content for a separate standard defined in software at a higher layer of the MAC/PHY according to the IEEE 802.11 standard in the WLAN chipset.

For example, in the case of a Wi-Fi network interface that follows Wi-Fi direct, an interface may be created according to the Wi-Fi direct standard, and in the case of Wi-Fi Aware, an interface may be created according to the Wi-Fi Aware standard. Here, the interface refers to the upper software protocol stack of the WLAN chipset that can control the WLAN chipsets by creating separate protocols based on the MAC/PHY standard protocol of the WLAN chipset, which follows the IEEE 802.11 standard. The application of the host processor may make the WLAN chipset operate according to the corresponding protocol when using the WLAN chipset by using the corresponding network interface.

For example, in the case of a mirroring application that creates a network interface using Wi-Fi direct, the device may be detected, and a connection may be established using a device called TV and the Wi-Fi direct standard protocol based on the IEEE 802.11 standard.

The network interface may create one or more network interfaces to control the WLAN chipset. For example, an electronic device may create an STA network interface to communicate with a Wi-Fi AP to establish a connection with the Wi-Fi AP that complies with the IEEE 802.11 standard, and an application that requires communication with an external server used by the user (e.g., an Internet browser) may utilize this STA interface. In order to perform mirroring on a TV with Wi-Fi direct, a device may be detected and connected using a signal in accordance with the Wi-Fi direct standard, and the mirroring application that transmits the Wi-Fi screen may be dedicated.

According to an example embodiment, each network interface may simultaneously control the WLAN chipset. For example, the STA network interface may be enabled to communicate with the Wi-Fi AP device through communication on the first link of the WLAN chipset. The Wi-Fi direct network interface may be used to transmit mirroring data to the TV through the second link, e.g., different network interfaces may simultaneously transmit different data to different devices through different links.

According to an example embodiment, the electronic device 210 and/or the external electronic device 220 may support multi-link operation (MLO). The multi-link operation may be an operation mode for transmitting or receiving data through a plurality of links (e.g., the first link 231, the second link 232). The multi-link operation may be an operation mode for transmitting or receiving data through a plurality of links based on a plurality of bands or channels, which is an operation mode to be introduced in IEEE 802.11be.

According to an example embodiment, the electronic device 210 may include a plurality of communication circuitries (e.g., a first communication circuitry 211 and/or a second communication circuitry 212) to support multi-link operation. The first communication circuitry 211 may transmit data to an external electronic device 220 through a first link 231 or receive data transmitted by the external electronic device 220 through the first link 231. The first communication circuitry 211 may output or receive a signal of a frequency band corresponding to the first link 231 through a first antenna 213. The second communication circuitry 212 may transmit data to the external electronic device 220 through the second link 232 or receive data transmitted by the external electronic device 220 through the second link 232. The second communication circuitry 212 may output or receive a signal of a frequency band corresponding to the second link 232 through the second antenna 214.

According to an example embodiment, the external electronic device 220 may include a plurality of communication circuitries (e.g., the third communication circuitry 221 and/or the fourth communication circuitry 222) to support multi-link operation. The third communication circuitry 221 may transmit data to the electronic device 210 through the first link 231 or receive data transmitted by the electronic device 210 through the first link 231. The third communication circuitry 221 may output or receive a signal of a frequency band corresponding to the first link 231 through the third antenna 223. The fourth communication circuitry 222 may transmit data to the electronic device 210 through the second link 232 or receive data transmitted by the electronic device 210 through the second link 232. The fourth communication circuitry 222 may output or receive a signal of a frequency band corresponding to the second link 232 through the fourth antenna 224.

According to an example embodiment, the frequency band of the first link 231 and the frequency band of the second link 232 may be different from each other. For example, the frequency band of the first link 231 may be 2.4 GHZ, and the frequency band of the second link 232 may be 5 GHz or 6 GHz. Alternatively, the frequency band of the first link 231 and the frequency band of the second link 232 may be the same, but the channel number of the first link 231 and the channel number of the second link 232 may be different. For example, the first link 231 may be channel 1 of a 2.4 GHz frequency band, and the second link 232 may be channel 12 of a 2.4 GHz frequency band.

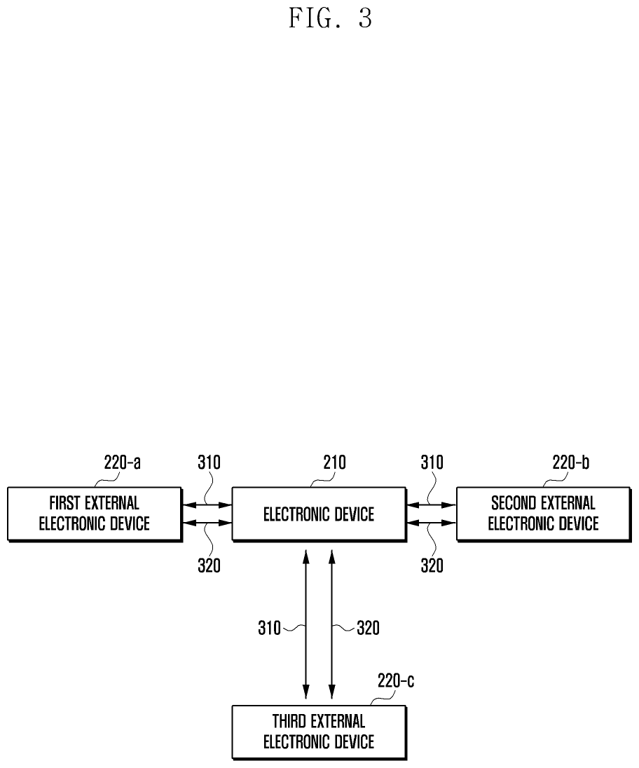

FIG. 3 is a diagram illustrating an electronic device, according to an example embodiment, performing a plurality of short-range wireless communications through a first link and/or a second link.

According to an example, the electronic device (e.g., the electronic device 210 of FIG. 2) may perform a first short-range wireless communication with the first external electronic device 220-a (e.g., the external electronic device 220 of FIG. 2). The first short-range wireless communication may include a variety of short-range wireless communications that the electronic device 210 and the first external electronic device 220-a can support. For example, the first short-range wireless communication may be Wi-Fi, which is a short-range wireless communication as defined by IEE 802.11. According to an example, the electronic device 210 and the first external electronic device 220-a may act as an access point (AP) or station (STA) as defined in IEEE 802.11.

The electronic device 210 and the first external electronic device 220-a may perform first short-range wireless communication using a plurality of links. With reference to FIG. 3, the electronic device 210 and the first external electronic device 220-a may perform first short-range wireless communication through a first link (e.g., the first link 231 of FIG. 2) 310 and a second link (e.g., the second link 232 of FIG. 2) 320. According to an example, the electronic device 210 may transmit data to the first external electronic device 220-a through the first short-range wireless communication using the first link 310 and the second link 320 and/or receive data from the first external electronic device 220-a through the first short-range wireless communication using the first link 310 and the second link 320. The electronic device 210 may simultaneously transmit/receive data through the first link and transmit/receive data through the second link. Simultaneous transmission/reception of data through the first link and transmission/reception of data through the second link may be referred to as real-simultaneous dual band (RSDB) or dual band simultaneous (DBS). In the following examples, it is assumed that the electronic device 210 may support simultaneous transmission/reception of data through the first link and transmission/reception of data through the second link.

According to an example, the frequency band of the first link 310 and the frequency band of the second link 320 may be different. The frequency band of the second link 320 may be greater than the frequency band of the first link 310. For example, the first link 310 may be a link having a frequency band in the 2.4 GHz band, and the second link 320 may be a link having a frequency band in the 5 GHz band. In another example, the first link 310 may be a link having a frequency band in the 2.4 GHz band, and the second link 320 may be a link having a frequency band in the 6 GHz band. In another example, the first link 310 may be a link having a frequency band in the 5 GHz band, and the second link 320 may be a link having a frequency band in the 6 GHz band.

The electronic device 210 and the first external electronic device 220-a may utilize the first channel of the first link and the second channel of the second link.

According to an example, the electronic device 210 may perform a second short-range wireless communication with the second external electronic device 220-b (e.g., the external electronic device 220 of FIG. 2). The second short-range wireless communication may include a variety of short-range wireless communications that the electronic device 210 and the second external electronic device 220-b can support. For example, the second short-range wireless communication may be one of Wi-Fi direct or a neighbor awareness network (NAN) as a device to device wireless communication.

The electronic device 210 and the second external electronic device 220-b may perform second short-range wireless communication using a plurality of links. With reference to FIG. 3, the electronic device 210 and the second external electronic device 220-B may perform second short-range wireless communication through the first link 310 and the second link 320. According to an example, the electronic device 210 may transmit data to the second external electronic device 220-b through the second short-range wireless communication using the first link 310 and the second link 320 and/or receive data from the second external electronic device 220-b through the second short-range wireless communication using the first link 310 and the second link 320.

The electronic device 210 and the second external electronic device 220-b may perform a second short-range wireless communication using the first link 310 established between the electronic device 210 and the second external electronic device 220-b. The channel of the first link 310 utilized to perform second short-range wireless communication may be the same as the first channel of the first link 310 utilized to perform first short-range wireless communication. The state in which the channel of the first link 310 utilized to perform second short-range wireless communication is the same as the first channel of the first link 310 utilized to perform first short-range wireless communication may be referred to as single channel concurrent (SCC). The electronic device 210 may simultaneously perform receiving data using the first short-range wireless communication and receiving data using the second short-range wireless communication in a state where the channel of the first link 310 utilized to perform second short-range wireless communication is the same as the first channel of the first link 310 utilized to perform first short-range wireless communication. In the electronic device 210, in a state where the channel of the first link 310 utilized to perform second short-range wireless communication is the same as the first channel of the first link 310 utilized to perform first short-range wireless communication, the transmission of the data using the first short-range wireless communication and the transmission of the data using the second short-range wireless communication cannot be performed simultaneously, and the transmission of the data using the first short-range wireless communication and the transmission of the data using the second short-range wireless communication can be performed sequentially through a contention process with each other.

The electronic device 210 and the second external electronic device 220-b may perform a second short-range wireless communication using the first link 310 established between the electronic device 210 and the second external electronic device 220-b. The channel of the first link utilized to perform second short-range wireless communication may be different from the first channel of the first link 310 utilized to perform first short-range wireless communication. The state in which the channel of the first link 310 utilized to perform second short-range wireless communication is different from the first channel of the first link 310 utilized to perform first short-range wireless communication may be referred to as multi-channels concurrent (MCC).

The electronic device 210 may perform operations (e.g., scheduling) to configure a time to perform the transmission/reception of data using the first short-range wireless communication and a time to perform the transmission/reception of data using the second short-range wireless communication in a state where the channel of the first link 310 utilized to perform second short-range wireless communication is different from the first channel of the first link 310 utilized to perform first short-range wireless communication. The electronic device 210 may perform first short-range wireless communication during configured time to perform the transmission/reception of data using the first short-range wireless communication, and may perform second short-range wireless communication during configured time to perform the transmission/reception of data using the second short-range wireless communication. The electronic device 210 may not perform second short-range wireless communication during configured time to perform the transmission/reception of data using the first short-range wireless communication. Further, the electronic device 210 may not perform first short-range wireless communication during configured time to perform the transmission/reception of data using the second short-range wireless communication.

The electronic device 210 and the second external electronic device 220-b may perform second short-range wireless communication using the second link 320 established between the electronic device 210 and the second external electronic device 220-b. The channel of the second link 320 utilized to perform second short-range wireless communication may be the same as the first channel of the second link 320 utilized to perform first short-range wireless communication. The state in which the channel of the second link 320 utilized to perform second short-range wireless communication is the same as the first channel of the second link 320 utilized to perform first short-range wireless communication may be referred to as single channel concurrent (SCC). The electronic device 210 may simultaneously perform receiving data using the first short-range wireless communication and receiving data using the second short-range wireless communication in a state where the channel of the second link 320 utilized to perform second short-range wireless communication is the same as the first channel of the second link 320 utilized to perform first short-range wireless communication. In the electronic device 210, in a state where the channel of the second link 320 utilized to perform second short-range wireless communication is the same as the first channel of the second link 320 utilized to perform first short-range wireless communication, the transmission of the data using the first short-range wireless communication and the transmission of the data using the second short-range wireless communication cannot be performed simultaneously, and the transmission of the data using the first short-range wireless communication and the transmission of the data using the second short-range wireless communication can be performed sequentially through a contention process with each other.

The electronic device 210 and the second external electronic device 220-b may perform second short-range wireless communication using the second link 320 established between the electronic device 210 and the second external electronic device 220-b. The channel of the second link 320 utilized to perform second short-range wireless communication may be different from the first channel of the second link 320 utilized to perform first short-range wireless communication. The state in which the channels of the second link 320 utilized to perform second short-range wireless communication are different from the first channels of the second link 320 utilized to perform first short-range wireless communication may be referred to as multi-channels concurrent (MCC).

The electronic device 210 may perform operations (e.g., scheduling) to configure a time to perform the transmission/reception of data using the first short-range wireless communication and a time to perform the transmission/reception of data using the second short-range wireless communication in a state where the channel of the second link 320 utilized to perform second short-range wireless communication is different from the first channel of the second link 320 utilized to perform first short-range wireless communication. The electronic device 210 may perform first short-range wireless communication during configured time to perform the transmission/reception of data using the first short-range wireless communication, and may perform second short-range wireless communication during configured time to perform the transmission/reception of data using the second short-range wireless communication. The electronic device 210 may not perform second short-range wireless communication during configured time to perform the transmission/reception of data using the first short-range wireless communication. Further, the electronic device 210 may not perform first short-range wireless communication during configured time to perform the transmission/reception of data using the second short-range wireless communication.

According to an example, the electronic device 210 may perform a third short-range wireless communication with a third external electronic device 220-c (e.g., the external electronic device 220 of FIG. 2). The third short-range wireless communication may include a variety of short-range wireless communications that the electronic device 210 and the third external electronic device 220-c can support. For example, the third short-range wireless communication may be one of a mobile hotspot or a soft AP.

The electronic device 210 and the third external electronic device 220-c may perform the third short-range wireless communication using a plurality of links. With reference to FIG. 3, the electronic device 210 and the third external electronic device 220-c may perform the third short-range wireless communication through the first link 310 and the second link 320. According to an example, the electronic device 210 may transmit data to the third external electronic device 220-c through the third short-range wireless communication using the first link 310 and the second link 320 and/or receive data from the third external electronic device 220-c through the third short-range wireless communication using the first link 310 and the second link 320.

The electronic device 210 and the third external electronic device 220-c may perform a third short-range wireless communication using the first link 310 established between the electronic device 210 and the third external electronic device 220-c.

The electronic device 210 may simultaneously perform the reception of data using the first short-range wireless communication, the reception of data using the second short-range wireless communication, and the reception of data using the third short-range wireless communication when the channel of the first link 310 utilized to perform first short-range wireless communication, the channel of the first link 310 utilized to perform second short-range wireless communication, and the channel of the first link 310 utilized to perform the third short-range wireless communication are the same (SCC). The electronic device 210 may not perform the transmission of the data using the first short-range wireless communication, the transmission of the data using the second short-range wireless communication, and the transmission of the data using the third short-range wireless communication simultaneously, and the transmission of the data using the first short-range wireless communication, the transmission of the data using the second short-range wireless communication, and the transmission of the data using the third short-range wireless communication may be performed sequentially through a contention process with each other.

The electronic device 210 may perform an operation (e.g., scheduling) to configure a time to perform the transmission/reception of data using the first short-range wireless communication, a time to perform the transmission/reception of data using the second short-range wireless communication, and a time to perform the transmission/reception of data using the third short-range wireless communication when at least two of the channels of the first link 310 utilized to perform first short-range wireless communication, the channel of the first link 310 utilized to perform second short-range wireless communication, and the channel of the first link 310 utilized to perform the third short-range wireless communication are different from each other (MCC). The electronic device 210 may perform first short-range wireless communication during configured time to perform the transmission/reception of data using the first short-range wireless communication, perform second short-range wireless communication during configured time to perform the transmission/reception of data using the second short-range wireless communication, and perform the third short-range wireless communication during configured time to perform the transmission/reception of data using the third short-range wireless communication.

The electronic device 210 and the third external electronic device 220-c may perform the third short-range wireless communication using the second link 320 established between the electronic device 210 and the third external electronic device 220-c.

The electronic device 210 may perform the reception of the data using the first short-range wireless communication, the reception of the data using the second short-range wireless communication, and the reception of the data using the third short-range wireless communication simultaneously when the channel of the second link 320 used to perform first short-range wireless communication, the channel of the second link 320 used to perform second short-range wireless communication, and the channel of the second link 320 used to perform the third short-range wireless communication are the same (SCC). In the electronic device 210, the transmission of the data using the first short-range wireless communication, the transmission of the data using the second short-range wireless communication, and the transmission of the data using the third short-range wireless communication may not be performed simultaneously, and the transmission of the data using the first short-range wireless communication, the transmission of the data using the second short-range wireless communication, and the transmission of the data using the third short-range wireless communication may be performed sequentially through a contention process with each other.

The electronic device 210 may perform an operation (e.g., scheduling) to configure a time to perform the transmission/reception of data using the first short-range wireless communication, a time to perform the transmission/reception of data using the second short-range wireless communication, and a time to perform the transmission/reception of data using the third short-range wireless communication when at least two of the channels of the second link 320 utilized to perform first short-range wireless communication, the channel of the second link 320 utilized to perform second short-range wireless communication, and the channel of the second link 320 utilized to perform the third short-range wireless communication are different from each other (MCC). The electronic device 210 may perform first short-range wireless communication during configured time to perform the transmission/reception of data using the first short-range wireless communication, perform second short-range wireless communication during configured time to perform the transmission/reception of data using the second short-range wireless communication, and perform the third short-range wireless communication during configured time to perform the transmission/reception of data using the third short-range wireless communication.

The electronic device 210 may have to perform appropriate scheduling of the plurality of links as the number of active short-range wireless communications increases. In the case that the electronic device 210 fails to perform proper scheduling, the electronic device 210 may not be able to perform data transmission and/or reception using some of the short-range wireless communications, and the quality of service using the short-range wireless communications may be degraded.

In the following, specific examples of how the electronic device 210 performs scheduling of the first link 310 and the second link 320 when the first short-range wireless communication, the second short-range wireless communication, and/or the third short-range wireless communication is activated will be described.

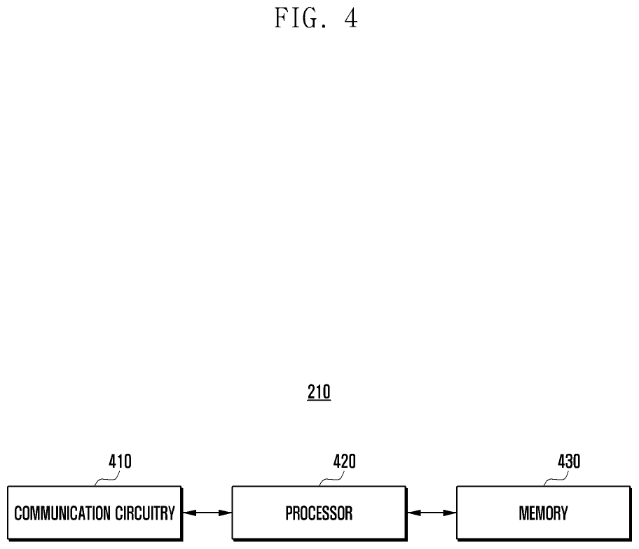

FIG. 4 is a block diagram of an electronic device according to an example embodiment.

According to an example embodiment, an electronic device (e.g., the electronic device 210 of FIG. 3) may include a communication circuitry 410 (e.g., the communication circuitry 160 of FIG. 1), a processor 420 (e.g., the processor 110 of FIG. 1, comprising processing circuitry), and/or a memory 430 (e.g., the memory 120 of FIG. 1).

The communication circuitry 410 may be or include a communication circuitry supporting a plurality of short-range wireless communications, including a first short-range wireless communication, a second short-range wireless communication, and/or a third short-range wireless communication.

For example, the first short-range wireless communication may be Wi-Fi, which is a short-range wireless communication as defined by IEEE 802.11. The second short-range wireless communication may be a device to device wireless communication, which may be either Wi-Fi direct or a neighbor awareness network (NAN). The third short-range wireless communication may be one of a mobile hotspot or a soft AP, as examples.

The communication circuitry 410 may generate separate interfaces for the first short-range wireless communication, the second short-range wireless communication, and/or the third short-range wireless communication. The communication circuitry 410 may generate an interface for the first short-range wireless communication in accordance with a standard for the first short-range wireless communication (e.g., IEEE 802.11), an interface for the second short-range wireless communication in accordance with a standard for the second short-range wireless communication, and an interface for the third short-range wireless communication in accordance with a standard for the third short-range wireless communication. The interface of the first short-range wireless communication may refer to an interface between the communication circuitry 410 and the processor 420 for performing the first short-range wireless communication. The processor 420 may control the communication circuitry 410 to perform first short-range wireless communication through the interface of the first short-range wireless communication. The processor 420, through the interface of the first short-range wireless communication, may control the communication circuitry 410 to operate in accordance with a standard of the first short-range wireless communication.

The interface of the second short-range wireless communication may refer to an interface, comprising interface circuitry, between the communication circuitry 410 and the processor 420 for performing the second short-range wireless communication. The processor 420 may control the communication circuitry 410 to perform second short-range wireless communication through the interface of the second short-range wireless communication. The processor 420 may control the communication circuitry 410, through the interface of the second short-range wireless communication, to cause the communication circuitry 410 to operate in accordance with a standard of the second short-range wireless communication.

The interface of the third short-range wireless communication may refer to an interface, comprising interface circuitry, between the communication circuitry 410 and the processor 420 for performing the third short-range wireless communication. The processor 420 may control the communication circuitry 410 to perform the third short-range wireless communication through the interface of the third short-range wireless communication. The processor 420 may control the communication circuitry 410, through the interface of the third short-range wireless communication, to cause the communication circuitry 410 to operate in accordance with a standard of the third short-range wireless communication.

The operation of the communication circuitry 410 and the processor 420 described below may be operated by utilizing the interface of the first short-range wireless communication, the interface of the second short-range wireless communication, and/or the interface of the third short-range wireless communication.

The communication circuitry 410 may include a variety of circuit structures used for modulation and/or demodulation of signals within the electronic device 210. For example, the communication circuitry 410 may modulate a baseband signal into a signal in the radio frequency (RF) band for output through the antenna (not shown), or demodulate a signal in the RF band received through the antenna into a signal in the baseband for transmission to the processor 420.

The communication circuitry 410 may perform first short-range wireless communication, the second short-range wireless communication, and/or the third short-range wireless communication through a first frequency band (e.g., 2.4 GHz), a second frequency band (e.g., 5 GHZ) that is a higher frequency band than the first frequency band, and/or a third frequency band (e.g., 6 GHZ) that is a higher frequency band than the second frequency band.

The communication circuitry 410 may support multi-link operation (MLO). The communication circuitry 410 MLO may supporting perform transmission/reception of data through the first link (e.g., the first link 310 in FIG. 3) and transmission/reception of data through the second link (e.g., the second link 320 in FIG. 3) simultaneously.

The communication circuitry 410 may support a simultaneous transmission and reception (STR) mode in which data may be simultaneously transmitted and/or received through a plurality of links, including the first link 310 and/or the second link 320. For example, the communication circuitry 410 may transmit and/or receive data to and/or from an external electronic device (e.g., the first external electronic device 220-a, the second external electronic device 220-b, and/or the third external electronic device 220-c of FIG. 3) through the second link 320 while transmitting or receiving data to or from the external electronic device (e.g., the first external electronic device 220-a, the second external electronic device 220-b, and/or the third external electronic device 220-c of FIG. 3) through the first link 310. However, in situations where the difference between the frequency band of the first link 310 and the frequency band of the second link 320 is less than or equal to a specified amount, the communication circuitry 410 may operate in a non-simultaneous transmission and reception (non-STR) mode to prevent or reduce interference between the transmission and reception of data through the first link 310 and the transmission and reception of data through the second link 320. Non-STR mode may indicate a mode in which the electronic device 210 does not receive data through the second link 320 when transmitting data through the first link 310.

According to an example, the frequency band of the first link 310 and the frequency band of the second link 320 may be different. The frequency band of the second link 320 may be greater than the frequency band of the first link 310. For example, the first link 310 may be a link having a frequency band in the 2.4 GHz band, and the second link 320 may be a link having a frequency band in the 5 GHz band. In another example, the first link 310 may be a link having a frequency band in the 2.4 GHz band, and the second link 320 may be a link having a frequency band in the 6 GHz band. In another example, the first link 310 may be a link having a frequency band in the 5 GHz band, and the second link 320 may be a link having a frequency band in the 6 GHz band.

According to an example, the frequency band of the first link 310 and the frequency band of the second link 320 may be the same as each other. When the frequency band of the first link 310 and the frequency band of the second link 320 are the same, the channels of the first link 310 and the channels of the second link 320 may be different. The performance of the channel of the second link 320 may be greater than the performance of the channel of the first link 310.

The communication circuitry 410 may, based on the control of the processor 420, perform operations to receive a signal transmitted by an external electronic device (e.g., the first external electronic device 220-a, the second external electronic device 220-b, and/or the third external electronic device 220-c of FIG. 3). The communication circuitry 410 may receive a signal from the processor 420 requesting to transmit and/or receive data through a particular channel, and may control components of the communication circuitry 410 (e.g., low noise amplifiers, switches, and/or filters) to receive the signal through a frequency band corresponding to the particular channel.

The processor 420 may perform operations to receive data transmitted by the application processor (e.g., the processor 110 of FIG. 1) and generate packets for transmitting the received data. The processor 420 may be defined as a communication processor included in the communication circuitry 410 or a processing circuitry included in a communication circuitry that performs short-range wireless communication. In an example, when the processor 420 is included in the communication circuitry 410 performing short-range wireless communication, the processor 420 may be referred to as a core. The processor 420 may be electrically or operatively coupled to the communication circuitry 410 to control the communication circuitry 410.

The memory 430 may store at least one computer program including instructions that may be executed by the processor 420. The operations of the processor 420 described herein may be performed in response to execution of instructions included in the computer program stored in the memory 430. In the case that the processor 420 includes at least one or more processing circuitries (or, processors), the instructions may be executed by the at least one or more processing circuitries (or, processors) included in the processor 420 individually or collectively.

The processor 420 may perform first short-range wireless communication using the first link 310 corresponding to the first frequency band and the second link 320 corresponding to the second frequency band (or, in MLO mode). The processor 420 may control the communication circuitry 410 to transmit data to the first external electronic device 220-a through the second link 320, or to receive data transmitted by the first external electronic device 220-a through the second link 320, while transmitting data to the first external electronic device 220-a through the first link 310 or receiving data transmitted by the first external electronic device 220-a through the first link 310.

According to an example, the first short-range wireless communication may include Wi-Fi, the electronic device 210 may operate as an STA, and the first external electronic device 220-a may operate as an AP. The electronic device 210 may transmit data through the first external electronic device 220-a to an external electronic device external to the short-range wireless communication system and/or receive data from an external electronic device external to the short-range wireless communication system.

The processor 420 may detect activation of the second short-range wireless communication while performing the first short-range wireless communication.

According to an example, the processor 420 may detect activation of the second short-range wireless communication in response to activation of an application and/or service using the second short-range wireless communication.

According to an example, the processor 420 may receive a request for activation of the second short-range wireless communication, transmitted by an external electronic device connected through the first short-range wireless communication or an external electronic device different from the external electronic device, and detect activation of the second short-range wireless communication.

According to an example, the second short-range wireless communication may refer to a short-range wireless communication between the electronic device 210 and a second external electronic device (e.g., the second external electronic device 220-b in FIG. 3). For example, the second short-range wireless communication may include a short-range wireless communication of any of Wi-Fi direct, neighbor awareness networking (NAN), and the like. The second short-range wireless communication may be a short-range wireless communication capable of transmitting and/or receiving data using the first link 310 and the second link 320. According to an example, the electronic device 210 may transmit data to the second external electronic device 220-b using the first link 310 and/or receive data from the second external electronic device 220-b using the first link 310 while transmitting data to the second external electronic device 220-b using the second link 320 and/or receiving data from the second external electronic device 220-b using the second link 320.

The electronic device 210 and the second external electronic device 220-B may perform a series of operations to activate the second short-range wireless communication.

According to an example, in the case that the second short-range wireless communication is a NAN, the electronic device 210 may activate the second short-range wireless communication by joining a NAN cluster that includes the second external electronic device 220-b. The processor 420 may receive a signal (e.g., a discovery beacon) transmitted by the second external electronic device 220-b or another external electronic device included in the NAN cluster including the second external electronic device 220-b, and identify information associated with the NAN cluster included in the discovery beacon. The information associated with the NAN cluster may include the start time, length, and periodicity of the discovery window (DW) of the NAN cluster. The information associated with the NAN cluster may include information indicating a channel of the second short-range wireless communication to be performed in the DW segment. The processor 420 may receive messages exchanged during the process of establishing the NAN data path with the second external electronic device 220-b and/or messages related to scheduling associated with the NAN communication (e.g., schedule update messages), and may identify the channel of the second short-range wireless communication based on the messages received. “Based on” as used herein covers based at least on.

The processor 420 may receive information indicating a channel of the short-range wireless communication and identify a channel of the first link 310 utilized to perform first short-range wireless communication and a channel of the first link 310 to be utilized to perform second short-range wireless communication. The processor 420 may identify whether the channel of the first link 310 utilized to perform first short-range wireless communication and the channel of the first link 310 to be utilized to perform second short-range wireless communication are the same.

The processor 420 may receive information indicating the channel of the short-range wireless communication and identify the channel of the second link 320 utilized to perform first short-range wireless communication and the channel of the second link 320 to be utilized to perform second short-range wireless communication. The processor 420 may identify whether the channel of the second link 320 utilized to perform first short-range wireless communication and the channel of the second link 320 to be utilized to perform second short-range wireless communication are the same.

According to an example, in the case that the second short-range wireless communication is Wi-Fi direct, the processor 420 may negotiate (or determine) a channel of the first link 310 and the second link 320 to be utilized in performing the second short-range wireless communication in the process of activating the second short-range wireless communication with the second external electronic device 220-b. The processor 420 may identify whether the channel of the first link 310 utilized to perform first short-range wireless communication and the channel of the first link 310 utilized to perform second short-range wireless communication are the same. The processor 420 may identify whether the channel of the second link 320 utilized to perform first short-range wireless communication and the channel of the second link 320 to be utilized to perform second short-range wireless communication are the same.

The processor 420 may not perform separate scheduling operations for the first link and the second link in the case that the processor 420 identifies that the same channel of the first link 310 is utilized to perform first short-range wireless communication and second short-range wireless communication, and the same channel of the second link 320 is utilized to perform first short-range wireless communication and second short-range wireless communication. In the case that the electronic device 210 utilizes the same channel of the first link 310 to perform first short-range wireless communication and second short-range wireless communication, and the same channel of the second link 320 to perform first short-range wireless communication and second short-range wireless communication (SCC), the electronic device 210 may simultaneously perform the reception of the signal through the first short-range wireless communication and the reception of the signal through the second short-range wireless communication. Therefore, the processor 420 may not perform separate scheduling operations for the first link and the second link.

The processor 420 may perform the scheduling for the first link 310 and the second link 320 in the case that the processor 420 identifies that the first short-range wireless communication and the second short-range wireless communication are performed using different channels of the first link 310 and the first short-range wireless communication and the second short-range wireless communication are performed using different channels of the second link 320.

The processor 420 may perform the scheduling for the first link 310 and the second link 320 in the case that the first short-range wireless communication and the second short-range wireless communication are performed using the same channel of the first link 310, and the second short-range wireless communication and the first short-range wireless communication are performed using the same channel of the second link 320, but that the service using the first short-range wireless communication and/or the second short-range wireless communication is a specified service type (e.g., a service type indicating a latency-sensitive service (e.g., voice call, video call)).

Scheduling for the first link 310 and the second link 320 may refer to configuring a time to perform a first short-range wireless communication through the first link 310, a time to perform a second short-range wireless communication through the first link 310, a time to perform a first short-range wireless communication through the second link 320, and/or a time to perform a second short-range wireless communication through the second link 320. The scheduling for the first link 310 and the second link 320 may also be referred to as scheduling the first short-range wireless communication and the second short-range wireless communication.

In performing the scheduling of the first link 310 and the second link 320, the processor 420 may consider the throughput of data transmitted/received through the first short-range wireless communication and the throughput of data transmitted/received through the second short-range wireless communication. The throughput of data transmitted/received through the first short-range wireless communication may be determined as the sum of the throughput of data transmitted/received through the first link 310 and the throughput of data transmitted/received through the second link 320. The processor 420 may identify (or monitor) the throughput of data transmitted/received through the first short-range wireless communication at every specified time while the first short-range wireless communication is activated. The processor 420 may determine a throughput required for a service activated through the first short-range wireless communication as a throughput of data to be transmitted/received through the first short-range wireless communication.

The throughput of data to be transmitted/received through the second short-range wireless communication may be determined as the sum of the throughput of data to be transmitted/received through the first link 310 and the throughput of data to be transmitted/received through the second link 320. According to an example, the processor 420 may determine a throughput required for a service to be activated through the second short-range wireless communication as a throughput of data to be transmitted/received through the second short-range wireless communication. Alternatively, the processor 420 may determine the throughput of data transmitted/received through the second short-range wireless communication by considering a history of the service to be activated through the second short-range wireless communication.

The processor 420 may perform scheduling of the first link 310 and the second link 320 based on the throughput of data transmitted/received through the first short-range wireless communication and the throughput of data transmitted/received through the second short-range wireless communication.

According to an example, the processor 420 may perform scheduling of the first link 310 and the second link 320 by comparing the throughput of data transmitted/received through the first short-range wireless communication and the throughput of data transmitted/received through the second short-range wireless communication, and allowing the short-range wireless communication having a higher throughput to occupy more of the second link 320. The frequency band of the second link 320 (e.g., 5 GHz or 6 GHz) may be higher than the frequency band of the first link 310 (e.g., 2.4 GHZ), and the time spent transmitting and/or receiving data through the second link 320 may be less than the time spent transmitting and/or receiving data through the first link 310. Therefore, the processor 420 may perform scheduling of the first link 310 and the second link 320 so that the short-range wireless communication having the higher throughput occupies more of the second link 320, thereby improving the quality of the short-range wireless communication having the higher throughput.

For example, the processor 420 may configure a first time for performing the second short-range wireless communication through the second link 320 to be longer than a second time for performing the first short-range wireless communication through the first link 310 in the case that the throughput of data transmitted/received through the first short-range wireless communication is less than the throughput of data transmitted/received through the second short-range wireless communication.

In another example, the processor 420 may configure the first time of performing the second short-range wireless communication through the second link 320 to be shorter than the second time of performing the first short-range wireless communication through the second link 320 in the case that the throughput of data transmitted/received through the first short-range wireless communication is greater than the throughput of data transmitted/received through the second short-range wireless communication.

The processor 420 may configure the ratio of the first time and the second time based on a ratio of the throughput of data transmitted/received through the first short-range wireless communication and the throughput of data transmitted/received through the second short-range wireless communication.

According to an example, the processor 420 may configure the first time length for performing the second short-range wireless communication through the second link 320 and the second time length for performing the first short-range wireless communication through the second link 320 to be equal in the case that the difference between the throughput of data transmitted/received through the first short-range wireless communication and the throughput of data transmitted/received through the second short-range wireless communication is less than or equal to a specified amount.

According to an example, the processor 420 may configure the first time length for performing the second short-range wireless communication through the second link 320 to be longer than the second time length for performing the first short-range wireless communication through the second link 320 in the case that the throughput of data transmitted/received through the first short-range wireless communication is less than the throughput of data transmitted/received through the second short-range wireless communication by a specified amount or more (or, exceeds). For example, the first time length may have a length equal to three times the second time length.

According to an example, the processor 420 may configure the first time length for performing the second short-range wireless communication through the second link 320 to be shorter than the second time length for performing the first short-range wireless communication through the second link 320 in the case that the throughput of data transmitted/received through the first short-range wireless communication is greater than the throughput of data transmitted/received through the second short-range wireless communication by a specified amount or more (or, exceeds). For example, the second time length may have three times the first time length.

According to an example, the processor 420 may configure the lengths of the first time and the second time based on a value (ratio) of the throughput of data transmitted/received through the first short-range wireless communication divided by the throughput of data transmitted/received through the second short-range wireless communication. The processor 420 may configure the ratio of the first time and the second time to be substantially equal to a value (ratio) of the throughput of data transmitted/received through the second short-range wireless communication divided by the throughput of data transmitted/received through the first short-range wireless communication. For example, in the case the throughput of the data to be transmitted/received through the second short-range wireless communication is three times the throughput of the data to be transmitted/received through the first short-range wireless communication, the length of the first time may be three times the length of the second time.

For example, as the value (ratio) of the throughput of data transmitted/received through the second short-range wireless communication divided by the throughput of data transmitted/received through the first short-range wireless communication increases, the first time of performing the second short-range wireless communication through the second link 320 may be further increased and the second time of performing the first short-range wireless communication through the second link 320 may be further decreased.

In another example, the processor 420 may decrease the first time of performing the second short-range wireless communication through the second link 320 and increase the second time of performing the first short-range wireless communication through the second link 320 as a value (ratio) of the throughput of data transmitted/received through the second short-range wireless communication divided by the throughput of data transmitted/received through the first short-range wireless communication decreases.

The processor 420 may decrease the first time of performing the second short-range wireless communication through the second link 320 and increase the second time of performing the first short-range wireless communication through the second link 320 in the case that the throughput of data transmitted/received through the first short-range wireless communication increases.

The processor 420 may perform scheduling of the first link 310 and the second link 320 to perform first short-range wireless communication through the first link 310 during the first time of performing the second short-range wireless communication through the second link 320, and the second time of performing the first short-range wireless communication through the first link 310 during the second time of performing the second short-range wireless communication through the second link 320. The processor 420 may perform scheduling of the first link 310 and the second link 320 to perform first short-range wireless communication through the first link 310 and the second short-range wireless communication through the second link 320 during the first time.

The processor 420 may perform scheduling of the first link 310 and the second link 320 to perform second short-range wireless communication through the first link 310 during the second time of performing the first short-range wireless communication through the second link 320. The processor 420 may perform scheduling of the first link 310 and the second link 320 to perform second short-range wireless communication through the first link 310 and the first short-range wireless communication through the second link 320 during the second time.

The foregoing examples utilize a throughput of first short-range wireless communication and a throughput of second short-range wireless communication. However, the electronic device 210 according to the present disclosure may also perform scheduling of the first link 310 and the second link 320 using parameters (e.g., latency) that have similar features to the throughput.

According to an example, the processor 420 may perform scheduling of the first link 310 and the second link 320 by comparing a latency required by the first short-range wireless communication and a latency required by the second short-range wireless communication, and allowing the short-range wireless communication requiring a lower latency to occupy more of the second link 320. The frequency band of the second link 320 (e.g., 5 GHz or 6 GHZ) may be higher than the frequency band of the first link 310 (e.g., 2.4 GHZ), and the time spent transmitting and/or receiving data through the second link 320 may be less than the time spent transmitting and/or receiving data through the first link 310.

Accordingly, the processor 420 may perform scheduling of the first link 310 and the second link 320 so that the lower latency short-range wireless communications occupy more of the second link 320, thereby improving the quality of the lower latency short-range wireless communications.

For example, the processor 420 may configure a first time for performing the second short-range wireless communication through the second link 320 to be longer than a second time for performing the first short-range wireless communication through the first link 310 in the case that the latency of the first short-range wireless communication is greater than the latency of the second short-range wireless communication.

In another example, the processor 420 may configure the first time of performing the second short-range wireless communication through the second link 320 to be shorter than the second time of performing the first short-range wireless communication through the second link 320 in the case that the latency of the first short-range wireless communication is less than the latency of the second short-range wireless communication.

The processor 420 may configure the ratio of the first time and the second time based on a ratio of the latency of the first short-range wireless communication and the latency of the second short-range wireless communication.

According to an example, the processor 420 may configure the length of the first time to perform second short-range wireless communication through the second link 320 and the length of the second time to perform first short-range wireless communication through the second link 320 to be the same, in the case that the difference between the latency of the first short-range wireless communication and the latency of the second short-range wireless communication is less than or equal to a specified amount.

According to an example, the processor 420 may configure the first time length for performing the second short-range wireless communication through the second link 320 to be longer than the second time length for performing the first short-range wireless communication through the second link 320 in the case that the latency of the first short-range wireless communication is greater than the latency of the second short-range wireless communication by a specified amount or more. For example, the first time length may have a length equal to three times the second time length.

According to an example, the processor 420 may configure the first time length for performing the second short-range wireless communication through the second link 320 to be shorter than the second time length for performing the first short-range wireless communication through the second link 320 in the case that the latency of the first short-range wireless communication is less than the latency of the second short-range wireless communication by a specified amount or more. For example, the second time length may have a length equal to three times the first time length.

According to an example, the processor 420 may perform first short-range wireless communication through the first link 310 during the first time and perform second short-range wireless communication through the first link 310 during the second time. The channel utilized by the first short-range wireless communication may be the same as the channel utilized by the second short-range wireless communication (e.g., single channel concurrent), or may be different (e.g., multi-channel concurrent).

According to an example, the processor 420 may perform second short-range wireless communication through the second link 320 during the first time and the first short-range wireless communication through the second link 320 during the second time. The channel utilized by the first short-range wireless communication may be the same as the channel utilized by the second short-range wireless communication (e.g., single channel concurrent) or may be different (e.g., multi-channel concurrent).

The example described above is the example where the processor 420 performs scheduling of the first link 310 and the second link 320 based on the throughput. The processor 420 may perform the scheduling of the first link 310 and the second link 320 based on a variety of parameters in addition to the throughput.

According to an example, the processor 420 may perform scheduling of the first link 310 and the second link 320 based on features of a first service performed through the first short-range wireless communication and features of a second service performed through the second short-range wireless communication. The processor 420 may perform the scheduling of the first link 310 and the second link 320 so that the first time length for performing the second short-range wireless communication through the second link 320 is longer than the second time length for performing the first short-range wireless communication through the second link 320, when the first service is a latency-insensitive service (e.g., a streaming service, a small data download service) and the second service is a latency-sensitive service (e.g., screen mirroring, which is a service that displays a screen that is displayed on a display of the electronic device 210 on a display of another electronic device (e.g., the second external electronic device 220-b), or display a screen that is displayed on a display of another electronic device (e.g., the second external electronic device 220-b) on a display of the electronic device 210, video calling, voice calling, or live broadcasting).

According to an example, the processor 420 may prioritize the first short-range wireless communication and the second short-range wireless communication based on various parameters (e.g., throughput of data transmitted/received through the first short-range wireless communication, features of the first service performed through the first short-range wireless communication, throughput of data transmitted/received through the second short-range wireless communication, and features of the second service performed through the second short-range wireless communication). The processor 420 may perform scheduling of the first link 310 and the second link 320 based on the prioritization of the first short-range wireless communication and the prioritization of the second short-range wireless communication.

According to an example, the priority of short-range wireless communication may be configured higher when the throughput is higher, and when the service through the short-range wireless communication corresponds to a latency sensitive service. Table 1 describes a scheduling scheme for the first link 310 and the second link 320 based on prioritization.

TABLE 1

| | 1st short- | 2nd short- | |
|---|---|---|---|
| | range wireless | range wireless | |
| | communication | communication | Scheduling method |
| Priority | HIGH | HIGH | The length of the first time and the length of the |
| | | | second time configured to be the same. |
| | | MID | The length of the second time configured to be |
| | | | X times the length of the first time (e.g., 3). |
| | | LOW | The second link 320 assigned to the first short- |
| | | | range wireless communication, the first link 310 |
| | | | assigned to the second short-range wireless |
| | | | communication. |
| | MID | HIGH | The length of the first time configured to be X |
| | | | times the length of the second time (e.g., 3). |
| | | MID | The length of the first time and the length of the |
| | | | second time configured to be the same. |
| | | LOW | The length of the second time configured to be |
| | | | X times the length of the first time (e.g., 3). |
| | LOW | HIGH | The second link 320 assigned to the second |
| | | | short-range wireless communication, the first |
| | | | link 310 assigned to the first short-range |
| | | | wireless communication. |
| | | MID | The length of the first time configured to be X |
| | | | times the length of the second time (e.g., 3). |
| | | LOW | The length of the first time and the length of the |
| | | | second time configured to be the same. |

The processor 420 may control the communication circuitry 410, based on the scheduling, to perform first short-range wireless communication using the first link 310 and the second short-range wireless communication using the second link 320 during a first time, and the first short-range wireless communication using the second link 320 and the second short-range wireless communication using the first link 310 during a second time.

The processor 420 may, based on the scheduling, control the communication circuitry 410 to perform first short-range wireless communication using the first link 310 and the second short-range wireless communication using the second link 320 during the first time. According to an example, in the case that the electronic device 210, the first external electronic device 210-a, and/or the second external electronic device 210-b supports a power saving mode, the processor 420 may control the communication circuitry 410 to transmit, prior to the start of the first time (or during the second time), a signal (e.g., a null data frame with the PM bit configured to a first value (e.g., 1)) indicating the entry into the power saving mode to the first external electronic device 210-a through the second link 320. As the first external electronic device 210-a receives a signal through the second link 320 indicating the entry into the power saving mode, it may not transmit data to the electronic device 210 through the second link 320 during the first time, and the electronic device 210 may not perform a first short-range wireless communication using the second link 320 during the first time. Accordingly, the electronic device 210 may perform second short-range wireless communication through the second link 320 during the first time. The processor 420 may control the communication circuitry 410 to transmit, prior to the start of the first time (or during the second time), a signal (e.g., a null data frame with the PM bit configured to a first value (e.g., 1)) indicating the entry into the power saving mode to the second external electronic device 210-b through the first link 310. As the second external electronic device 210-b receives a signal through the first link 310 indicating the entry into the power-saving mode, it may not transmit data to the electronic device 210 through the first link 310 during the first time, and the electronic device 210 may not perform a second short-range wireless communication using the first link 310 during the first time. Therefore, the electronic device 210 may perform first short-range wireless communication through the first link 310 during the first time.

The processor 420 may, based on scheduling, control the communication circuitry 410 to perform first short-range wireless communication through the second link 320 and the second short-range wireless communication through the first link 310 during the second time. According to an example, in the case that the electronic device 210, the first external electronic device 210-a, and/or the second external electronic device 210-b support a power saving mode, the processor 420 may control to transmit, prior to the start of the second time (or during the first time), a signal (e.g., a null data frame with the PM bit set to a first value (e.g., 1)) indicating the entry into the power saving mode to the second external electronic device 210-b through the second link 320. As the second external electronic device 210-b receives a signal through the second link 320 indicating the entry into the power saving mode, it may not transmit data to the electronic device 210 through the second link 320 for a second period of time, and the electronic device 210 may not perform a second short-range wireless communication using the second link 320 for a second period of time. Therefore, the electronic device 210 may perform first short-range wireless communication through the second link 320 during the second time. The processor 420 may control the communication circuitry 410 to transmit, prior to the start of the second time, a signal (e.g., a null data frame with the PM bit set to a first value (e.g., 1)) indicating the entry into the power saving mode to the first external electronic device 210-a through the first link 310. As the first external electronic device 210-a receives a signal through the first link 310 indicating the entry into the power saving mode, it may not transmit data to the electronic device 210 through the first link 310 for a second period of time, and the electronic device 210 may not perform a first short-range wireless communication using the first link 310 for a second period of time. Therefore, the electronic device 210 may perform second short-range wireless communication through the first link 310 during the second time.

The processor 420 may, based on scheduling, control the communication circuitry 410 to perform first short-range wireless communication through the first link 310 and the second short-range wireless communication through the second link 320 during the first time. According to an example, in the case that the electronic device 210, the first external electronic device 210-a, and/or the second external electronic device 210-b support TID-to-mapping, the processor 420 may control the communication circuitry 410 to transmit, prior to the start of the first time (or during the second time), a signal to the first external electronic device 210-a to deactivate the second link 320 (e.g., no data to be transmitted/received through the second link 320). As the first external electronic device 210-a receives a signal through the second link 320 to deactivate the second link 320, data may not be transmitted to the electronic device 210 through the second link 320 during the first time, and the electronic device 210 may not perform a first short-range wireless communication using the second link 320 during the first time. Therefore, the electronic device 210 may perform second short-range wireless communication through the second link 320 during the first time. The processor 420 may control the communication circuitry 410 to transmit, prior to the start of the first time, a signal to the second external electronic device 210-b through the first link 310 to deactivate the first link 310. As the second external electronic device 210-b receives the signal for deactivating the first link 310 through the first link 310, it may not transmit data to the electronic device 210 through the first link 310 during the first time, and the electronic device 210 may not perform second short-range wireless communication using the first link 310 during the first time. Therefore, the electronic device 210 may perform first short-range wireless communication through the first link 310 during the first time.

The processor 420 may, based on scheduling, control the communication circuitry 410 to perform first short-range wireless communication through the second link 320 and the second short-range wireless communication through the first link 310 during the second time. According to an example, in the case that the electronic device 210, the first external electronic device 210-a, and/or the second external electronic device 210-b support TID-to-mapping, the processor 420 may control the communication circuitry 410 to transmit, prior to the start of the second time (or during the first time), a signal to the second external electronic device 210-b to deactivate the second link 320 (e.g., no data to be transmitted/received through the second link 320). As the second external electronic device 210-b receives the signal through the second link 320 to deactivate the second link 320, it may not transmit data to the electronic device 210 through the second link 320 for a second period of time, and the electronic device 210 may not perform a second short-range wireless communication using the second link 320 for a second period of time. Therefore, the electronic device 210 may perform first short-range wireless communication through the second link 320 during the second time. The processor 420 may control the communication circuitry 410 to transmit, prior to the start of the second time (or during the first time), a signal to the first external electronic device 210-a to deactivate the first link 310 through the first link 310. The first external electronic device 210-a receives the signal for deactivating the first link 310 through the first link 310, it may not transmit data to the electronic device 210 through the first link 310 for a second period of time, and the electronic device 210 may not perform a first short-range wireless communication using the first link 310 for a second period of time. Therefore, the electronic device 210 may perform second short-range wireless communication through the first link 310 during the second time.

The processor 420 may, based on the scheduling, control the communication circuitry 410 to perform the first short-range wireless communication using the first link 310 and the second short-range wireless communication using the second link 320 during a first time and the first short-range wireless communication using the second link 320 and the second short-range wireless communication using the first link 310 during a second time. In the case that the electronic device 210, the first external electronic device 220-a, and the second external electronic device 220-b support a target wake time (TWT) protocol, the electronic device 210 may transmit parameters including a length of the first time, a start point of the first time, and/or an interval of the first time to the first external electronic device 220-a through the first link 310 and parameters including a length of the second time, a start point of the second time, and/or an interval of the second time to the first external electronic device 220-a through the second link 320. The electronic device 210 and the first external electronic device 220-a may perform a first short-range wireless communication through the first link 310 during the first time based on the length, start point, and/or interval of the first time, and a second short-range wireless communication through the second link 320 during the second time based on the length, start point, and/or interval of the second time.

The electronic device 210 may transmit a parameter including the length of the first time, the start point of the first time, and/or the interval of the first time to the second external electronic device 220-b through the second link 320, and a parameter including the length of the second time, the start point of the second time, and/or the interval of the second time to the second external electronic device 220-b through the first link 310. The electronic device 210 and the second external electronic device 220-b may perform second short-range wireless communication through the second link 320 during the first time based on the length, start point and/or interval of the first time, and may perform first short-range wireless communication through the first link 310 during the second time based on the length, start point and/or interval of the second time.

The processor 420 may identify (or monitor) the degree to which the first short-range wireless communication and/or second short-range wireless communication actually occupies the first link 310 and the second link 320 while performing the first short-range communication and the second short-range wireless communication based on scheduling, and may update (or modify) the scheduling based on the degree of actual occupation. According to an example, the processor 420 may compare the first time with the time to perform second short-range wireless communication using the second link 320 during the first time, and when the time to perform second short-range wireless communication is less than the first time by a specified amount or more, the first time may be reduced and the second time to perform first short-range wireless communication using the second link 320 may be increased.

The processor 420 may detect activation of the third short-range wireless communication while performing first short-range wireless communication and second short-range wireless communication. The third short-range wireless communication may include various short-range wireless communications that may be supported by the electronic device 210 and the third external electronic device 220-c. For example, the third short-range wireless communication may be either a mobile hotspot or a soft AP.

In response to detecting the activation of the third short-range wireless communication, the processor 420 may configure the third short-range wireless communication to be performed through any one of the first link 310 and the second link 320. The processor 420 may configure first short-range wireless communication and second short-range wireless communication to be performed through the other of the first link 310 and the second link 320.

According to an example, the processor 420 may compare the throughput of data to be transmitted/received through the third short-range wireless communication (e.g., the minimum throughput required by the service to be activated through the third short-range wireless communication) with the throughput of data to be transmitted/received through the first short-range wireless communication and the throughput of data to be transmitted/received through the second short-range wireless communication, and select a link to be allocated to the third short-range wireless communication based on the comparison result. According to an example, the processor 420 may control the communication circuitry 410 to perform the third short-range wireless communication through the second link using the higher frequency when the throughput (e.g., the minimum throughput required by the service to be activated through the third short-range wireless communication) of data to be transmitted/received through the third short-range wireless communication is greater than the throughput of data to be transmitted/received through the first short-range wireless communication and the throughput of data to/received through the second short-range wireless communication. According to an example, when the throughput (e.g., the minimum throughput required by the service to be activated through the third short-range wireless communication) of data to be transmitted/received through the third short-range wireless communication is less than the throughput of data transmitted/received through the first short-range wireless communication and the throughput of data transmitted/received through the second short-range wireless communication, the processor 420 may control the communication circuitry 410 to perform the third short-range wireless communication through the first link 310 using a lower frequency band.

Based on the throughput of data transmitted/received through the first short-range wireless communication and the throughput of data transmitted/received through the second short-range wireless communication, the processor 420 may determine the length of the third time for the first short-range wireless communication to occupy the other link and the length of the fourth time for the second short-range wireless communication to occupy the other link. The processor 420 may perform scheduling of the other link based on the determined length.

According to an example, the processor 420 may perform scheduling of another link so that the length of the third time is longer than the length of the fourth time when the throughput of data transmitted/received through the first short-range wireless communication is greater than the throughput of data transmitted/received through the second short-range wireless communication.

According to an example, when the throughput of data transmitted/received through the first short-range wireless communication is less than the throughput of data transmitted/received through the second short-range wireless communication, the processor 420 may perform scheduling of another link so that the length of the third time is shorter than the length of the fourth time.

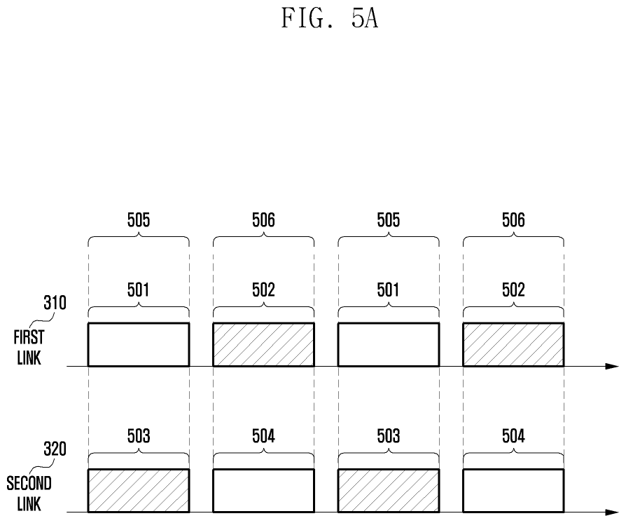

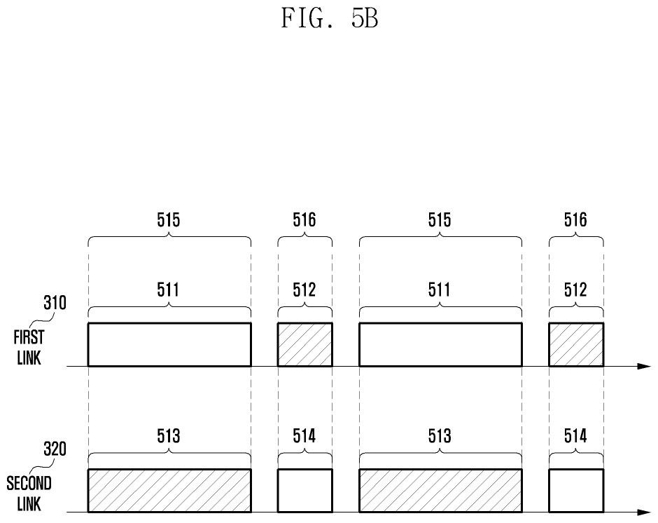

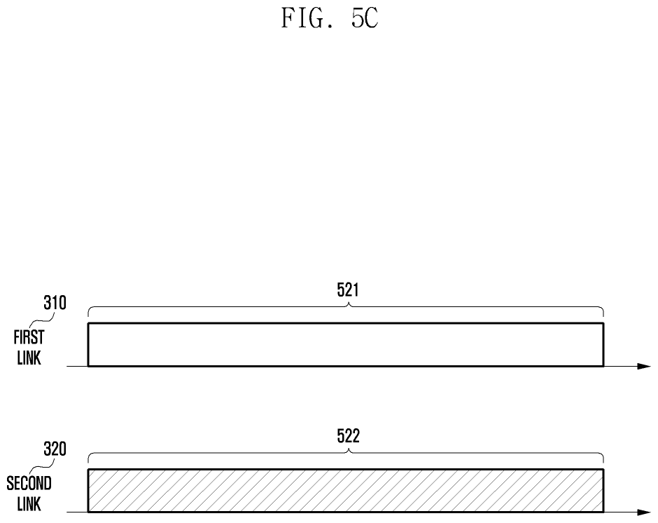

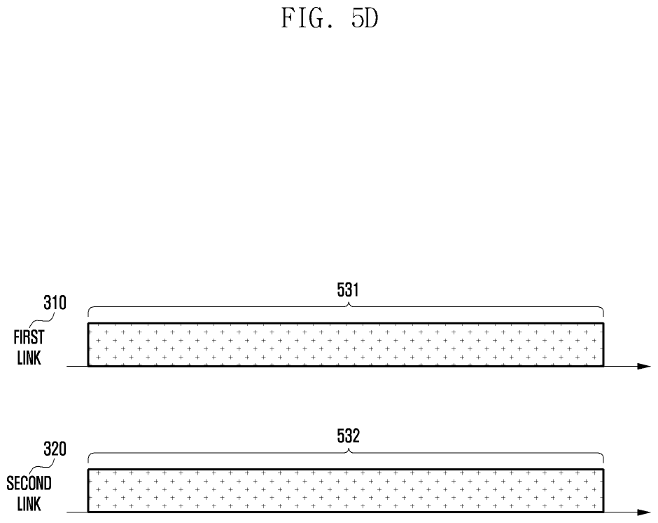

FIGS. 5A, 5B, 5C, and 5D are diagrams illustrating schedule examples of a first link and a second link configured by an electronic device according to an embodiment.

According to an example, the electronic device (e.g., the electronic device 210 of FIG. 4) may perform scheduling of the first link (e.g., the first link 310 of FIG. 3) and the second link (e.g., the second link 320 of FIG. 3).

The electronic device 210 may perform scheduling of the first link 310 and the second link 320 when it is identified that the first short-range communication and the second short-range wireless communication are performed using different channels of the first link 310 and the first short-range communication and the second short-range wireless communication are performed using different channels of the second link 320.

The electronic device 210 may perform first short-range wireless communication and second short-range wireless communication using the same channel of the first link 310, and perform first short-range wireless communication and second short-range wireless communication using the same channel of the second link 320, but in the case that it is identified that the service using the first short-range wireless communication and/or the second short-range wireless communication is a specified service type (e.g., a service type indicating a delay-sensitive service (e.g., voice call, video call)), the scheduling of the first link 310 and the second link 320 may be performed.

The scheduling of the first link 310 and the second link 320 may refer to configuring a time for performing first short-range wireless communication through the first link 310, a time for performing second short-range wireless communication using the first link 310, a time for performing first short-range wireless communication using a second link 320 and/or a time for performing second short-range wireless communication using the second link 320. The scheduling of the first link 310 and the second link 320 may also be referred to as the scheduling of the first short-range wireless communication and the second short-range wireless communication.

When scheduling the first link 310 and the second link 320, the electronic device 210 may consider a throughput of data transmitted/received through the first short-range wireless communication and a throughput of data transmitted/received through the second short-range wireless communication. The throughput of data transmitted/received through the first short-range wireless communication may be determined as the sum of the throughput of data transmitted/received through the first link 310 and data transmitted/received through the second link 320. The electronic device 210 may identify (or monitor) the throughput of data transmitted/received through the first short-range wireless communication at every specified time while the first short-range wireless communication is activated. The electronic device 210 may determine a throughput required for a service activated through the first short-range wireless communication as a throughput of data to be transmitted/received through the first short-range wireless communication.

The throughput of data to be transmitted/received through the second short-range wireless communication may be determined as the sum of the throughput of data to be transmitted/received through the first link 310 and data to be transmitted/received through the second link 320. According to an example, the electronic device 210 may determine a throughput required for a service to be activated through the second short-range wireless communication as a throughput of data to be transmitted/received through the second short-range wireless communication. Alternatively, the electronic device 210 may determine a throughput of data transmitted/received through the second short-range wireless communication in consideration of a history of a service to be activated through the second short-range wireless communication.

The electronic device 210 may perform scheduling of the first link 310 and the second link 320 based on the throughput of data transmitted/received through the first short-range wireless communication and the throughput of data transmitted/received through the second short-range wireless communication.

According to an example, the electronic device 210 may compare the throughput of data transmitted/received through the first short-range wireless communication and the throughput of data transmitted/received through the second short-range wireless communication, and perform scheduling of the first link 310 and the second link 320 so that short-range wireless communication having a higher throughput may occupy the second link 320 more. The frequency band of the second link 320 (e.g., 5 GHz or 6 GHz) may be higher than the frequency band of the first link 310 (e.g., 2.4 GHz), and the time required for data transmission and/or reception through the second link 320 may be less than the time required for data transmission and/or reception through the first link 310. Therefore, the electronic device 210 may improve the quality of short-range wireless communication having a higher throughput by scheduling the first link 310 and the second link 320 so that short-range wireless communication having a higher throughput occupies the second link 320 more.

For example, when the throughput of data transmitted/received through the first short-range wireless communication is less than the throughput of data transmitted/received through the second short-range wireless communication, the electronic device 210 may configure the first time to perform second short-range wireless communication through the second link 320 longer than the second time to perform first short-range wireless communication through the second link 320.

For another example, when the throughput of data transmitted/received through the first short-range wireless communication is greater than the throughput of data transmitted/received through the second short-range wireless communication, the electronic device 210 may configure the first time for performing the second short-range wireless communication through the second link 320 to be shorter than the second time for performing the first short-range wireless communication through the second link 320.

The electronic device 210 may configure the ratio of the first time and the second time based on the ratio of the throughput of data transmitted/received through the first short-range wireless communication and the throughput of data transmitted/received through the second short-range wireless communication.

According to an example, when the throughput of data transmitted/received through the first short-range wireless communication and the throughput of data transmitted/received through the second short-range wireless communication are less than or equal to the specified amount, the electronic device 210 may configure the length of the first time for performing the second short-range wireless communication through the second link 320 and the length of the second time for performing the first short-range wireless communication through the second link 320 to be the same.

With reference to FIG. 5A, the electronic device 210 may perform scheduling of the first link 310 and the second link 320 so that the first short-range wireless communication 501 using the first link 310 and the second short-range wireless communication 503 using the second link 320 are performed during the first time 505, and the first short-range wireless communication 504 using the second link 320 and the second short-range wireless communication 502 using the first link 310 are performed during the second time 506. The electronic device 210 may configure the lengths of the first time 505 and the second time 506 to be the same.

According to an example, when the throughput of data transmitted/received through the first short-range wireless communication is greater than (or exceeds) the throughput of data transmitted/received through the second short-range wireless communication, the electronic device 210 may configure the length of the first time for performing the second short-range wireless communication through the second link 320 to be longer than the length of the second time. For example, the length of the first time may be three times the length of the second time.

With reference to FIG. 5B, the electronic device 210 may perform scheduling of the first link 310 and the second link 320 so that the first short-range wireless communication 511 using the first link 310 and the second short-range wireless communication 513 using the second link 320 are performed during the first time 515, and the first short-range wireless communication 514 using the second link 320 and the second short-range wireless communication 512 using the first link 310 are performed during the second time 516. The electronic device 210 may configure the length of the first time 515 to be longer than the length of the second time 516.

With reference to FIG. 5C, the electronic device 210 may perform scheduling of the first link 310 and the second link 320 to perform first short-range wireless communication 521 using the first link 310 and second short-range wireless communication 522 using the second link 320 when the throughput of data transmitted/received through the first short-range wireless communication is relatively significantly different from the throughput of data transmitted/received through the second short-range wireless communication and when the priority of the first short-range wireless communication (e.g., LOW in Table 1) is lower than the priority of the second short-range wireless communication (e.g., HIGH in Table 1).

According to an example, when it is identified that the electronic device 210 performs first short-range wireless communication and second short-range wireless communication using the same channel of the first link 310 and performs first short-range wireless communication and second short-range wireless communication using the same channel of the second link 320, separate scheduling operations for the first link 310 and the second link 320 may not be performed. When the electronic device 210 performs first short-range wireless communication and second short-range wireless communication using the same channel of the first link 310 and performs first short-range wireless communication and second short-range wireless communication using the same channel of the second link 320 (SCC), the electronic device 210 may simultaneously receive a signal through the first short-range wireless communication and a signal through the second short-range wireless communication. Therefore, the electronic device 210 may not perform separate scheduling operations for the first link 310 and the second link 320. Not performing separate scheduling operations for the first link 310 and the second link 320 may refer to not making separate restrictions on the electronic device 210 performing 531 first short-range wireless communication and second short-range wireless communication on the first link 310 and performing 532 on the second link 320. Not making separate restrictions on performing 531 first short-range wireless communication and second short-range wireless communication on the first link 310 and performing 532 on the second link 320 may refer to not configuring the electronic device 210 not to perform first short-range wireless communication (or second short-range wireless communication) through a specific link for a specific time or not configuring the electronic device 210 to perform first short-range wireless communication (or second short-range wireless communication) through a specific link for a specific time. The electronic device 210 may sequentially perform data transmission using the first short-range wireless communication and data transmission using the second short-range wireless communication through a contention process in the case that there are no separate restrictions on performing 531 first short-range wireless communication and second short-range wireless communication on the first link 310 and the second link 320.

With reference to FIG. 5D, the electronic device 210 may simultaneously perform the receiving 531 of data using the first short-range wireless communication and the receiving 532 of data using the second short-range wireless communication in a state where the channel of the second link 320 utilized to perform the second short-range wireless communication is the same as the first channel of the second link 320 utilized to perform the first short-range wireless communication. The electronic device 210 may not perform simultaneously the transmission of the data using the first short-range wireless communication and the transmission of the data using the second short-range wireless communication, in a state where the channel of the second link 320 utilized to perform the second short-range wireless communication is the same as the first channel of the second link 320 utilized to perform the first short-range wireless communication, and the transmission of the data using the first short-range wireless communication and the transmission of the data using the second short-range wireless communication may be performed sequentially in a contention process with each other.

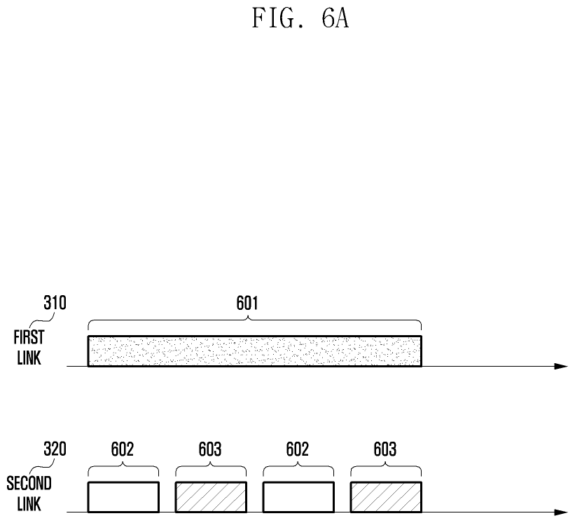

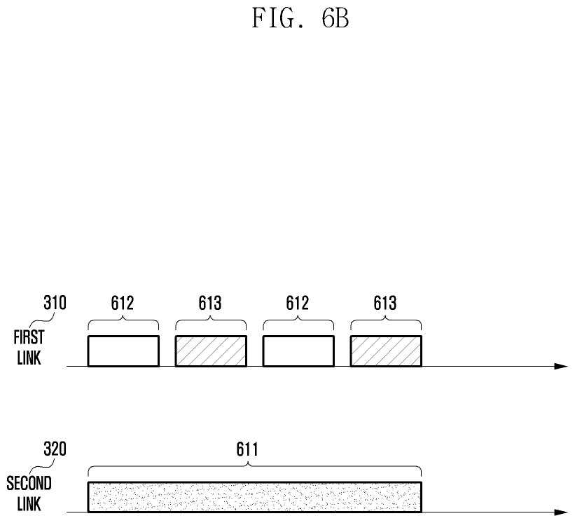

FIGS. 6A and 6B are diagrams illustrating examples of schedules of a first link and a second link configured by an electronic device according to an embodiment.

The electronic device (e.g., the electronic device 210 of FIG. 4) may detect activation of the third short-range wireless communication while performing first short-range wireless communication and second short-range wireless communication. The third short-range wireless communication may include various short-range wireless communications that may be supported by the electronic device 210 and the third external electronic device (e.g., the third external electronic device 220-c of FIG. 3). For example, the third short-range wireless communication may be either a mobile hotspot or a soft AP.

When the electronic device 210 detects the activation of the third short-range wireless communication, the electronic device 210 may configure the third short-range wireless communication to be performed through any one of the first link 310 and the second link 320. When the third short-range wireless communication is a short-range wireless communication that requires continuous transmission and/or reception of signals (e.g., the soft AP may require the electronic device 210 to transmit a beacon signal at every specified time), the third short-range wireless communication may have to occupy one link alone or exclusively. Accordingly, the electronic device 210 may secure (or improve) the quality of service using the third short-range wireless communication by configuring the third short-range wireless communication to be performed through any one of the first link 310 and the second link 320.

The electronic device 210 may configure the first short-range wireless communication and the second short-range wireless communication to be performed through the other one of the first link 310 and the second link 320.

According to an example, the electronic device 210 may compare the throughput of data to be transmitted/received through the third short-range wireless communication (e.g., the minimum throughput required by the service to be activated through the third short-range wireless communication) with the throughput of data to be transmitted/received through the first short-range wireless communication, and select a link to be allocated to the third short-range wireless communication based on the comparison result.

According to an example, the electronic device 210 may control the communication circuitry 410 to perform the third short-range wireless communication using the lower frequency band when the throughput of data to be transmitted/received (e.g., the minimum throughput required by the service to be activated through the third short-range wireless communication) is less than the throughput of data to be transmitted/received through the first short-range wireless communication and the throughput of data to/from the second short-range wireless communication.

With reference to FIG. 6A, the electronic device 210 may control the communication circuitry 410 to perform the third short-range wireless communication 601 through the first link 310, and control the communication circuitry 410 to perform the first short-range wireless communication 602 and perform second short-range wireless communication 603 through the second link 320.

According to an example, the electronic device 210 may control the communication circuitry 410 to perform the third short-range wireless communication using the higher frequency band when the throughput of data to be transmitted/received (e.g., the minimum throughput required by the service to be activated through the third short-range wireless communication) is greater than the throughput of data to be transmitted/received through the first short-range wireless communication and the throughput of data to/from the second short-range wireless communication.

With reference to FIG. 6B, the electronic device 210 may control the communication circuitry 410 to perform first short-range wireless communication 612 and the second short-range wireless communication 613 through the first link 310, and control the communication circuitry 410 to perform the third short-range wireless communication 611 through the second link 320.

FIGS. 6A and 6B illustrate that the length of the third time when the first short-range wireless communication occupies the other link and the length of the fourth time when the second short-range wireless communication occupies the other link are the same, but the electronic device 210 may determine the length of the third time when the first short-range wireless communication occupies the other link and the length of the fourth time when the second short-range wireless communication occupies the other link based on the throughput of data transmitted/received through the first short-range wireless communication and the throughput of data transmitted/received through the second short-range wireless communication. The electronic device 210 may perform scheduling of the other link based on the determined length.

According to an example, the electronic device 210 may perform scheduling of another link so that the length of the third time is longer than the length of the fourth time when the throughput of data transmitted/received through the first short-range wireless communication is greater than the throughput of data transmitted/received through the second short-range wireless communication.

According to an example, the electronic device 210 may perform scheduling of another link so that the length of the third time is shorter than the length of the fourth time when the throughput of data transmitted/received through the first short-range wireless communication is less than the throughput of data transmitted/received through the second short-range wireless communication.

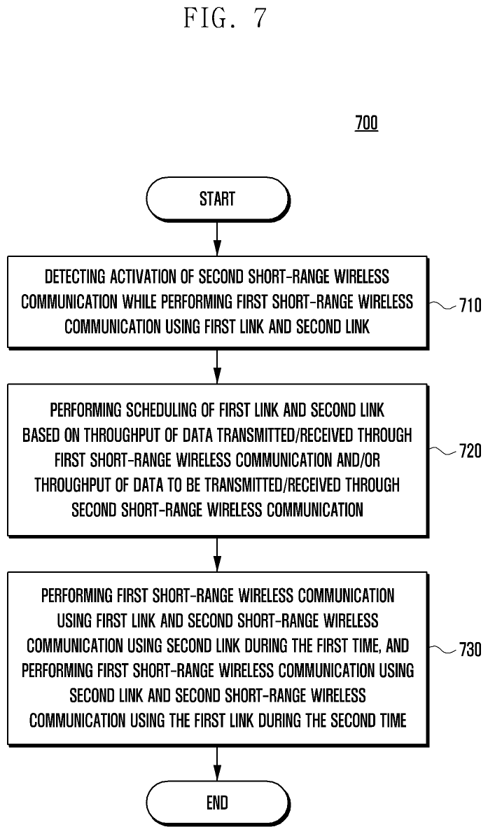

FIG. 7 is a flowchart 700 illustrating an operating method of an electronic device according to an example embodiment.

In operation 710, the electronic device (e.g., the electronic device 210 of FIG. 4) may detect the activation of the second short-range wireless communication while performing the first short-range wireless communication using the first link (e.g., the first link 310 of FIG. 3) and the second link (e.g., the second link 320 of FIG. 3).

The electronic device 210 may perform first short-range wireless communication using the first link 310 corresponding to the first frequency band and the second link 320 corresponding to the second frequency band (or in the MLO mode). The electronic device 210 may control the communication circuitry 410 to transmit data to the first external electronic device 220-a through the first link 310, or to receive data transmitted by the first external electronic device 220-a through the first link 310, while simultaneously transmitting data to the first external electronic device 220-a through the second link 320, or receiving data transmitted by the first external electronic device 220-a through the second link 320.

According to an example, the first short-range wireless communication may include Wi-Fi, the electronic device 210 may operate as an STA, and the first external electronic device 220-a may operate as an AP. The electronic device 210 may transmit data to an external electronic device existing outside the short-range wireless communication system through the first external electronic device 220-a and/or receive data from an external electronic device existing outside the short-range wireless communication system.

The electronic device 210 may detect the activation of the second short-range wireless communication while performing the first short-range wireless communication.

According to an example, the second short-range wireless communication may refer to short-range wireless communication between the electronic device 210 and a second external electronic device (e.g., the second external electronic device 220-b of FIG. 3). For example, the second short-range wireless communication may include any one of Wi-Fi direct and neighbor awareness networking (NAN). The second short-range wireless communication may be short-range wireless communication capable of transmitting and/or receiving data using the first link 310 and the second link 320. According to an example, the electronic device 210 may transmit data to the second external electronic device 220-b using the first link 310 and/or receive data from the second external electronic device 220-b using the first link 310, while transmitting data to the second external electronic device 220-b using the second link 320, and/or receiving data to the second external electronic device 220-b using the second link 320.

The electronic device 210 and the second external electronic device 220-b may perform a series of operations for activating the second short-range wireless communication.

According to an example, when the second short-range wireless communication is a NAN, the electronic device 210 may participate in the NAN cluster including the second external electronic device 220-b to activate the second short-range wireless communication. The electronic device 210 may receive a signal (e.g., a discovery beacon) transmitted by the second external electronic device 220-b or another external electronic device included in the NAN cluster including the second external electronic device 220-b, and identify information related to the NAN cluster included in the discovery beacon. The information related to the NAN cluster may include a start point, a length, and a period of the discovery window of the NAN cluster. The information related to the NAN cluster may include information indicating a channel of the second short-range wireless communication to be performed in the DW section. The electronic device 210 may receive a message exchanged in the process of setting a NAN data path with the second external electronic device 220-b and/or a message related to a schedule related to NAN communication (e.g., schedule update message), and identify a channel of the second short-range wireless communication based on the received message.

In operation 720, the electronic device 210 may perform scheduling of the first link 310 and the second link 320 based on the throughput of data transmitted/received through the first short-range wireless communication and/or the throughput of data to be transmitted/received through the second short-range wireless communication.

Scheduling for the first link 310 and the second link 320 may refer to configuring a time for performing first short-range wireless communication through the first link 310, a time for performing second short-range wireless communication using the first link 310, a time for performing first short-range wireless communication using the second link 320, and/or a time for performing second short-range wireless communication using the second link 320. Scheduling for the first link 310 and the second link 320 may also be referred to as scheduling of the first short-range wireless communication and the second short-range wireless communication.

When scheduling the first link 310 and the second link 320, the electronic device 210 may consider a throughput of data transmitted/received through the first short-range wireless communication and a throughput of data transmitted/received through the second short-range wireless communication. The throughput of data transmitted/received through the first short-range wireless communication may be determined as the sum of the throughput of data transmitted/received through the first link 310 and data transmitted/received through the second link 320. The electronic device 210 may identify (or monitor) the throughput of data transmitted/received through the first short-range wireless communication at every specified time while the first short-range wireless communication is activated. The electronic device 210 may determine a throughput required for a service activated through the first short-range wireless communication as a throughput of data to be transmitted/received through the first short-range wireless communication.

The throughput of data to be transmitted/received through the second short-range wireless communication may be determined as the sum of the throughput of data to be transmitted/received through the first link 310 and data to be transmitted/received through the second link 320. According to an example, the electronic device 210 may determine a throughput required for a service to be activated through the second short-range wireless communication as a throughput of data to be transmitted/received through the second short-range wireless communication. Alternatively, the electronic device 210 may determine a throughput of data transmitted/received through the second short-range wireless communication in consideration of a history of a service to be activated through the second short-range wireless communication.

The electronic device 210 may perform scheduling of the first link 310 and the second link 320 based on the throughput of data transmitted/received through the first short-range wireless communication and the throughput of data transmitted/received through the second short-range wireless communication.

According to an example, the electronic device 210 may compare the throughput of data transmitted/received through the first short-range wireless communication and the throughput of data transmitted/received through the second short-range wireless communication, and perform scheduling of the first link 310 and the second link 320 so that the short-range wireless communication having a higher throughput may occupy the second link 320 more. The frequency band of the second link 320 (e.g., 5 GHz or 6 GHz) may be higher than the frequency band of the first link 310 (e.g., 2.4 GHz), and the time required for data transmission and/or reception through the second link 320 may be less than the time required for data transmission and/or reception through the first link 310. Therefore, the electronic device 210 may improve the quality of short-range wireless communication having a higher throughput by scheduling the first link 310 and the second link 320 so that the short-range wireless communication having a higher throughput occupies the second link 320 more.

For example, when the throughput of data transmitted/received through the first short-range wireless communication is less than the throughput of data transmitted/received through the second short-range wireless communication, the electronic device 210 may configure the first time to perform second short-range wireless communication through the second link 320 longer than the second time to perform first short-range wireless communication through the second link 320.

For another example, when the throughput of data transmitted/received through the first short-range wireless communication is greater than the throughput of data transmitted/received through the second short-range wireless communication, the electronic device 210 may configure the first time to perform second short-range wireless communication through the second link 320 to be shorter than the second time to perform first short-range wireless communication through the second link 320.

The electronic device 210 may configure the ratio of the first time and the second time based on the ratio of the throughput of the data transmitted/received through the first short-range wireless communication and the throughput of the data transmitted/received through the second short-range wireless communication.

According to an example, when the throughput of data transmitted/received through the first short-range wireless communication and the throughput of data transmitted/received through the second short-range wireless communication are less than or equal to the specified amount, the electronic device 210 may configure the same length of the first time for performing the second short-range wireless communication through the second link 320 and the second time for performing the first short-range wireless communication through the second link 320.

According to an example, when the throughput of data transmitted/received through the first short-range wireless communication is less than the throughput of data transmitted/received through the second short-range wireless communication, the electronic device 210 may configure the length of the first time for performing the second short-range wireless communication through the second link 320 to be longer than the length of the second time. For example, the length of the first time may be three times the length of the second time.

According to an example, when the throughput of data transmitted/received through the first short-range wireless communication is greater than the throughput of data transmitted/received through the second short-range wireless communication, the electronic device 210 may configure the length of the first time for performing the second short-range wireless communication through the second link 320 to be shorter than the length of the second time for performing the first short-range wireless communication through the second link 320. The length of the second time may be three times the length of the first time.

According to an example, the electronic device 210 may configure the length of the first time and the second time based on a value (ratio) obtained by dividing the throughput of data transmitted/received through the first short-range wireless communication by the throughput of data transmitted/received through the second short-range wireless communication. The electronic device 210 may configure a ratio of the first time and the second time to substantially the same value (ratio) obtained by dividing the throughput of data transmitted/received through the second short-range wireless communication. For example, when the throughput of data to be transmitted/received through the second short-range wireless communication is three times the throughput of data to be transmitted/received through the first short-range wireless communication, the length of the first time may be three times the length of the second time.

For example, as the value (ratio) obtained by dividing the throughput of data transmitted/received through the second short-range wireless communication by the throughput of data transmitted/received through the first short-range wireless communication increases, the first time to perform second short-range wireless communication through the second link 320 may increase and the second time to perform first short-range wireless communication through the second link 320 may decrease.

For another example, as the value (ratio) obtained by dividing the throughput of data transmitted/received through the second short-range wireless communication by the throughput of data transmitted/received through the first short-range wireless communication decreases, the electronic device 210 may reduce the first time to perform second short-range wireless communication through the second link 320 and increase the second time to perform first short-range wireless communication through the second link 320.

When the throughput of data transmitted/received through the first short-range wireless communication increases, the electronic device 210 may reduce the first time to perform second short-range wireless communication through the second link 320 and increase the second time to perform first short-range wireless communication through the second link 320.

The electronic device 210 may perform scheduling of the first link 310 and the second link 320 to perform first short-range wireless communication through the first link 310 during the first time when the second short-range wireless communication is performed through the second link 320. The electronic device 210 may perform scheduling of the first link 310 and the second short-range wireless communication through the first link 310 during the first time.

The electronic device 210 may perform scheduling of the first link 310 and the second link 320 to perform second short-range wireless communication through the first link 310 during the second time when the first short-range wireless communication is performed through the second link 320. The electronic device 210 may perform scheduling of the first link 310 and the second link 320 to perform second short-range wireless communication through the first link 310 and the first short-range wireless communication through the second link 320.

The above-described example is an example in which the electronic device 210 performs scheduling of the first link 310 and the second link 320 based on a throughput. The electronic device 210 may perform scheduling of the first link 310 and the second link 320 in consideration of various parameters as well as throughput.

According to an example, the electronic device 210 may perform scheduling of the first link 310 and the second link 320 based on the features of the first service performed through the first short-range wireless communication and the features of the second service performed through the second short-range wireless communication. The processor 420 may perform the scheduling of the first link 310 and the second link 320 so that the first time length for performing the second short-range wireless communication through the second link 320 is longer than the second time length for performing the first short-range wireless communication through the second link 320, when the first service is a latency-insensitive service (e.g., a streaming service, a small data download service) and the second service is a latency-sensitive service (e.g., screen mirroring, which is a service that displays a screen that is displayed on a display of the electronic device 210 on a display of another electronic device (e.g., the second external electronic device 220-b), or display a screen that is displayed on a display of another electronic device (e.g., the second external electronic device 220-b) on a display of the electronic device 210, video calling, voice calling, or live broadcasting). Each “processor” herein may comprise one or more processors comprising processing circuitry.

According to an example, the electronic device 210 may configure the priorities of the first short-range wireless communication and the second short-range wireless communication based on various parameters (e.g., the throughput of data transmitted and received through the first short-range wireless communication, the throughput of data transmitted and received through the second short-range wireless communication, and the second service features). The electronic device 210 may perform scheduling of the first link 310 and the second link 320 based on the priority of the first short-range wireless communication and the priority of the second short-range wireless communication.

According to an example, the priority of short-range wireless communication may be configured higher as the throughput is higher and the service through short-range wireless communication corresponds to a latency sensitive service.

In operation 730, the electronic device 210 may perform first short-range wireless communication using the first link 310 and second short-range wireless communication using the second link 320 during the first time, and perform first short-range wireless communication using the second link 320 and second short-range wireless communication using the first link 310 during the second time.

The electronic device 210 may control the communication circuitry 410 to perform first short-range wireless communication using the first link 310 and the second short-range wireless communication using the second link 320 during the first time and to perform first short-range wireless communication using the second link 320 and the second short-range wireless communication using the first link 310 during the second time based on scheduling.

The electronic device 210 may control the communication circuitry 410 to perform first short-range wireless communication using the first link 310 and the second short-range wireless communication using the second link 320 during a first time based on scheduling. According to an example, when the electronic device 210, the first external electronic device 210-a, and/or the second external electronic device 210-b support a power saving mode, the electronic device 210 may control the communication circuitry 410 to transmit a signal (e.g., a null data frame with the PM bit configured to a first value (e.g., 1)) indicating the entry into the power saving mode through the second link 320 before the first time starts (or during a second time). As the first external electronic device 210-a receives the signal indicating the entry into the power saving mode through the second link 320, the data may not be transmitted to the electronic device 210 through the second link 320 during the first time, and the electronic device 210 may not perform first short-range wireless communication using the second link 320 during the first time. Accordingly, the electronic device 210 may perform second short-range wireless communication through the second link 320 during the first time. The electronic device 210 may control the communication circuitry 410 to transmit a signal (e.g., a null data frame with the PM bit configured to a first value (e.g., 1)) indicating the entry into the power saving mode through the first link 310 to the second external electronic device 210-b before the first time starts (or during the second time). As the second external electronic device 210-b receives a signal indicating the entry into the power saving mode through the first link 310, data may not be transmitted to the electronic device 210 through the first link 310 during a first time, and the electronic device 210 may not perform second short-range wireless communication using the first link 310 during a first time. Accordingly, the electronic device 210 may perform first short-range wireless communication through the first link 310 during a first time.

The electronic device 210 may control the communication circuitry 410 to perform first short-range wireless communication using the second link 320 and the second short-range wireless communication using the first link 310 during a second time based on scheduling. According to an example, when the electronic device 210, the first external electronic device 210-a, and/or the second external electronic device 210-b support a power saving mode, the electronic device 210 may control the communication circuitry 410 to transmit a signal (e.g., a null data frame with the PM bit configured to a first value (e.g., 1)) indicating the entry into the power saving mode through the second link 320 before the second time starts (or during a first time) to the second external electronic device 210-b). As the second external electronic device 210-b receives a signal indicating the entry into the power saving mode through the second link 320, the data may not be transmitted to the electronic device 210 through the second link 320 during a second time, and the electronic device 210 may not perform second short-range wireless communication using the second link 320 during a second time. Accordingly, the electronic device 210 may perform first short-range wireless communication through the second link 320 during a second time. The electronic device 210 may control the communication circuitry 410 to transmit a signal (e.g., a null data frame with the PM bit configured to a first value (e.g., 1)) indicating the entry into the power saving mode to the first external electronic device 210-a before the second time begins. As the first external electronic device 210-a receives a signal indicating the entry into the power saving mode through the first link 310, data may not be transmitted to the electronic device 210 through the first link 310 during a second time, and the electronic device 210 may not perform first short-range wireless communication using the first link 310 during a second time. Accordingly, the electronic device 210 may perform second short-range wireless communication through the first link 310 during a second time.

The electronic device 210 may control the communication circuitry 410 to perform first short-range wireless communication using the first link 310 and second short-range wireless communication using the second link 320 during a first time based on scheduling. According to an example, when the electronic device 210, the first external electronic device 210-a, and/or the second external electronic device 210-b support TID-to-mapping, the electronic device 210 may control the communication circuitry 410 to transmit a signal (e.g., no data to be transmitted/received through the second link 320) for deactivating the second link 320 to the first external electronic device 210-a before the first time starts (or during a second time). As the first external electronic device 210-a receives the signal for deactivating the second link 320 through the second link 320, data may not be transmitted to the electronic device 210 through the second link 320 during the first time, and the electronic device 210 may not perform first short-range wireless communication using the second link 320 during the first time. Accordingly, the electronic device 210 may perform second short-range wireless communication through the second link 320 during the first time. The electronic device 210 may control the communication circuitry 410 to transmit a signal for deactivating the first link 310 to the second external electronic device 210-b before the first time starts (or during a second time). As the second external electronic device 210-b receives the signal for deactivating the first link 310 through the first link 310, data may not be transmitted to the electronic device 210 through the first link 310 during the first time, and the electronic device 210 may not perform second short-range wireless communication using the first link 310 during the first time. Accordingly, the electronic device 210 may perform first short-range wireless communication through the first link 310 during the first time.

The electronic device 210 may control the communication circuitry 410 to perform first short-range wireless communication using the second link 320 and second short-range wireless communication using the first link 310 during a second time based on scheduling. According to an example, when the electronic device 210, the first external electronic device 210-a, and/or the second external electronic device 210-b support TID-to-mapping, the electronic device 210 may control the communication circuitry 410 to transmit a signal (e.g., no data to be transmitted/received through the second link 320) for deactivating the second link 320 to the second external electronic device 210-b before the second time starts (or during a first time). As the second external electronic device 210-b receives the signal for deactivating the second link 320 through the second link 320, the data may not be transmitted to the electronic device 210 through the second link 320 during a second time, and the electronic device 210 may not perform second short-range wireless communication using the second link 320 during a second time. Accordingly, the electronic device 210 may perform first short-range wireless communication through the second link 320 during the second time. The electronic device 210 may control the communication circuitry 410 to transmit a signal for deactivating the first link 310 to the first external electronic device 210-a before the second time starts (or during the first time). As the first external electronic device 210-a receives the signal for deactivating the first link 310 through the first link 310, data may not be transmitted to the electronic device 210 through the first link 310 during the second time, and the electronic device 210 may not perform first short-range wireless communication using the first link 310 during the second time. Accordingly, the electronic device 210 may perform second short-range wireless communication through the first link 310 during the second time.

The electronic device 210 may control the communication circuitry 410 to perform first short-range wireless communication using the first link 310 and the second short-range wireless communication using the second link 320 during a first time, and to perform first short-range wireless communication using the second link 310 during a second time based on scheduling. When the electronic device 210, the first external electronic device 220-a, and the second external electronic device 220-b support the target wake time (TWT) protocol, the electronic device 210 may transmit a parameter including a length of the first time, a start point of the first time, and/or an interval of the first time through the first link 310, to the first external electronic device 220-a through the first link 310, and a parameter including a length of the second time, a start point of the second time, and/or an interval of the second time through the second link 320 may be transmitted to the first external electronic device 220-a. The electronic device 210 and the first external electronic device 220-a may perform first short-range wireless communication through the first link 310 during the first time based on the length, start point, and/or interval of the first time, and may perform first short-range wireless communication through the second link 320 during the second time based on the length, start point and/or interval of the second time.

The electronic device 210 may transmit a parameter including the length of the first time, the start point of the first time, and/or the interval of the first time to the second external electronic device 220-b through the second link 320, and may transmit a parameter including the length of the second time, the start point of the second time, and/or the interval of the second time to the second external electronic device 220-b through the first link 310. The electronic device 210 and the second external electronic device 220-b may perform second short-range wireless communication through the second link 320 during the first time based on the length, start point, and/or interval of the second time, and may perform first short-range wireless communication through the first link 310 during the second time based on the length, start point and/or interval of the second time.

The electronic device 210 may identify (or monitor) the degree to which the first short-range wireless communication and/or the second short-range wireless communication actually occupies the first link 310 and the second link 320 while performing first short-range wireless communication and second short-range wireless communication based on scheduling, and may update (or modify) the scheduling based on the degree of actual occupation. According to an example, the electronic device 210 may compare the time to perform second short-range wireless communication using the second link 320 during the first time and the first time, and in the case that the time to perform second short-range wireless communication is less than the first time by a specified amount or more, the first time may be reduced and the second time to perform first short-range wireless communication using the second link 320 may be increased.

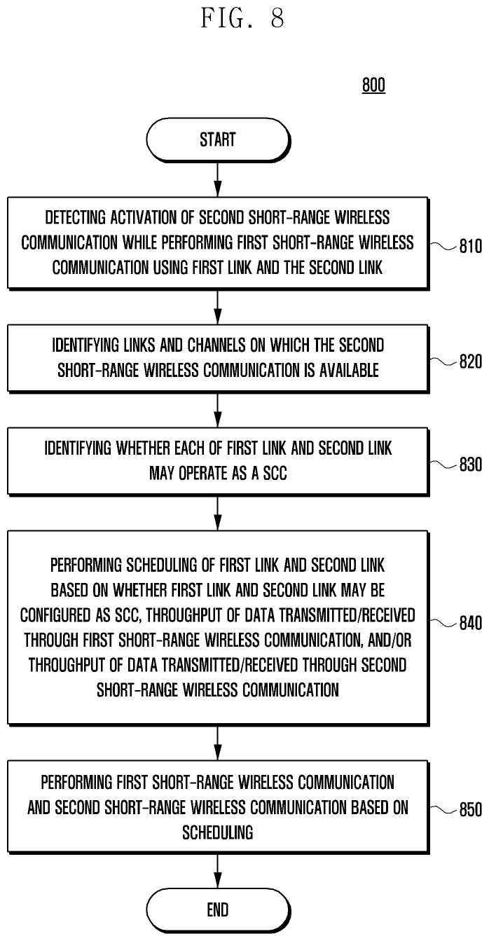

FIG. 8 is a flowchart 800 illustrating an operating method of an electronic device according to an embodiment.

In operation 810, the electronic device (e.g., the electronic device 210 of FIG. 4) may detect the activation of the second short-range wireless communication while performing the first short-range wireless communication using the first link (e.g., the first link 310 of FIG. 3) and the second link (e.g., the second link 320 of FIG. 3).

The electronic device 210 may perform first short-range wireless communication using the first link 310 corresponding to the first frequency band and the second link 320 corresponding to the second frequency band (or in the MLO mode). The electronic device 210 may control the communication circuitry 410 to transmit data to the first external electronic device 220-a through the first link 310, or to receive data transmitted by the first external electronic device 220-a through the first link 310, while simultaneously transmitting data to the first external electronic device 220-a through the second link 320, or receiving data transmitted by the first external electronic device 220-a through the second link 320.

According to an example, the first short-range wireless communication may include Wi-Fi, the electronic device 210 may operate as an STA, and the first external electronic device 220-a may operate as an AP. The electronic device 210 may transmit data to an external electronic device existing outside the short-range wireless communication system through the first external electronic device 220-a and/or receive data from an external electronic device existing outside the short-range wireless communication system.

The electronic device 210 may detect the activation of the second short-range wireless communication while performing the first short-range wireless communication.

According to an example, the second short-range wireless communication may refer to short-range wireless communication between the electronic device 210 and a second external electronic device (e.g., the second external electronic device 220-b of FIG. 3). For example, the second short-range wireless communication may include any one of Wi-Fi direct and neighbor awareness networking (NAN). The second short-range wireless communication may be a short-range wireless communication capable of transmitting and/or receiving data using the first link 310 and the second link 320. According to an example, while transmitting data to the second external electronic device 220-b using the first link 310 and/or receiving data from the second external electronic device 220-b using the first link 310, the electronic device 210 may transmit data to the second external electronic device 220-b using the second link 320 and/or receive data to the second external electronic device 220-b using the second link 320.

In operation 820, the electronic device 210 may identify links and channels on which the second short-range wireless communication is available.

The electronic device 210 and the second external electronic device 220-b may perform a series of operations for activating the second short-range wireless communication.

According to an example, when the second short-range wireless communication is a NAN, the electronic device 210 may participate in the NAN cluster including the second external electronic device 220-b to activate the second short-range wireless communication. The electronic device 210 may receive a signal (e.g., a discovery beacon) transmitted by the second external electronic device 220-b or another external electronic device included in the NAN cluster including the second external electronic device 220-b, and identify information related to the NAN cluster included in the discovery beacon. The information related to the NAN cluster may include a start point, a length, and a period of the discovery window of the NAN cluster. The information related to the NAN cluster may include information indicating a channel of the second short-range wireless communication to be performed in the DW section. The electronic device 210 may receive a message exchanged in the process of configuring a NAN data path with the second external electronic device 220-b and/or a message related to a schedule related to NAN communication (e.g., a schedule update message), and may identify a channel of the second short-range wireless communication based on the received message.

The electronic device 210 may receive information indicating the channel of the short-range wireless communication and identify the channel of the first link 310 used to perform first short-range wireless communication and the channel of the first link 310 used to perform second short-range wireless communication.

In operation 830, the electronic device 210 may identify whether each of the first link 310 and the second link 320 may operate as a single channel con-current (SCC).

The electronic device 210 may identify whether the channel of the first link 310 used to perform first short-range wireless communication and the channel of the first link 310 used to perform second short-range wireless communication are the same.

The electronic device 210 may receive information indicating a channel of short-range wireless communication, and may identify a channel of the second link 320 used to perform the first short-range wireless communication and a channel of the second link 320 to be used to perform the second short-range wireless communication. The electronic device 210 may identify whether the channel of the second link 320 used to perform the first short-range wireless communication is the same as the channel of the second link 320 to be used to perform the second short-range wireless communication.

According to an example, when the second short-range wireless communication is Wi-Fi direct, the electronic device 210 may negotiate (or determine) the channels of the first link 310 and the second link 320 to be used to perform the second short-range wireless communication in the process of activating the second short-range wireless communication with the second external electronic device 220-b. The electronic device 210 may identify whether the channel of the first link 310 used to perform the first short-range wireless communication is the same as the channel of the first link 310 to be used to perform the second short-range wireless communication. The electronic device 210 may identify whether the channel of the second link 320 used to perform the first short-range wireless communication is the same as the channel of the second link 320 to be used to perform the second short-range wireless communication.

When identifying that the electronic device 210 performs first short-range wireless communication and second short-range wireless communication using the same channel of the first link 310 and performs first short-range wireless communication and second short-range wireless communication using the same channel of the second link 320, the electronic device 210 may not perform separate scheduling operations for the first link and the second link. When the electronic device 210 performs first short-range wireless communication and second short-range wireless communication using the same channel of the first link 310, and performs first short-range wireless communication and second short-range wireless communication using the same channel of the second link 320 (SCC), the electronic device 210 may simultaneously receive the signal through the first short-range wireless communication and the signal through the second short-range wireless communication. Accordingly, the electronic device 210 may not perform the separate scheduling operation for the first link 310 and the second link 320. Not making separate restrictions on performing first short-range wireless communication and second short-range wireless communication on the first link 310 and the second link 320 may refer to not configuring the electronic device 210 not to perform the first short-range wireless communication (or the second short-range wireless communication) through a specific link for a specific time or not configuring the electronic device 210 to perform the first short-range wireless communication (or the second short-range wireless communication) through a specific link for a specific time. The electronic device 210 may sequentially perform data transmission using the first short-range wireless communication and data transmission using the second short-range wireless communication through a contention process in the case that there are no separate restrictions on performing first short-range wireless communication and second short-range wireless communication on the first link 310 and the second link 320.

The electronic device 210 may perform scheduling of the first link 310 and the second link 320 when it is identified that the first short-range communication and the second short-range wireless communication are performed using different channels of the first link 310 and the first short-range communication and the second short-range wireless communication are performed using different channels of the second link 320.

The electronic device 210 may perform first short-range wireless communication and second short-range wireless communication using the same channel of the first link 310, and perform first short-range wireless communication and second short-range wireless communication using the same channel of the second link 320, but in the case that it is identified that the service using the first short-range wireless communication and/or the second short-range wireless communication is a specified service type (e.g., a service type indicating a delay-sensitive service (e.g., voice call, video call)), scheduling of the first link 310 and the second link 320 may be performed.

In operation 840, the electronic device 210 may perform scheduling of the first link 310 and the second link 320 based on whether the first link 310 and the second link 320 may be configured as SCC, the throughput of data transmitted/received through the first short-range wireless communication, and/or the throughput of data transmitted/received through the second short-range wireless communication.

Scheduling for the first link 310 and the second link 320 may refer to configuring a time for performing first short-range wireless communication through the first link 310, a time for performing second short-range wireless communication using the first link 310, a time for performing first short-range wireless communication using the second link 320, and/or a time for performing second short-range wireless communication using the second link 320. Scheduling for the first link 310 and the second link 320 may also be referred to as scheduling of the first short-range wireless communication and the second short-range wireless communication.

When scheduling the first link 310 and the second link 320, the electronic device 210 may consider a throughput of data transmitted/received through the first short-range wireless communication and a throughput of data transmitted/received through the second short-range wireless communication. The throughput of data transmitted/received through the first short-range wireless communication may be determined as the sum of the throughput of data transmitted/received through the first link 310 and data transmitted/received through the second link 320. The electronic device 210 may identify (or monitor) the throughput of data transmitted/received through the first short-range wireless communication at every specified time while the first short-range wireless communication is activated. The electronic device 210 may determine a throughput required for a service activated through the first short-range wireless communication as a throughput of data to be transmitted/received through the first short-range wireless communication.

The throughput of data to be transmitted/received through the second short-range wireless communication may be determined as the sum of the throughput of data to be transmitted/received through the first link 310 and data to be transmitted/received through the second link 320. According to an example, the electronic device 210 may determine a throughput required for a service to be activated through the second short-range wireless communication as a throughput of data to be transmitted/received through the second short-range wireless communication. Alternatively, the electronic device 210 may determine a throughput of data transmitted/received through the second short-range wireless communication in consideration of a history of a service to be activated through the second short-range wireless communication.

The electronic device 210 may perform scheduling of the first link 310 and the second link 320 based on the throughput of data transmitted/received through the first short-range wireless communication and the throughput of data transmitted/received through the second short-range wireless communication.

According to an example, the electronic device 210 may compare the throughput of data transmitted/received through the first short-range wireless communication and the throughput of data transmitted/received through the second short-range wireless communication, and perform scheduling of the first link 310 and the second link 320 so that short-range wireless communication having a higher throughput may occupy the second link 320 more. The frequency band of the second link 320 (e.g., 5 GHz or 6 GHz) may be higher than the frequency band of the first link 310 (e.g., 2.4 GHz), and the time required for data transmission and/or reception through the second link 320 may be less than the time required for data transmission and/or reception through the first link 310. Therefore, the electronic device 210 may improve the quality of short-range wireless communication having a higher throughput by scheduling the first link 310 and the second link 320 so that short-range wireless communication having a higher throughput occupies the second link 320 more.

For example, when the throughput of data transmitted/received through the first short-range wireless communication is less than the throughput of data transmitted/received through the second short-range wireless communication, the electronic device 210 may configure the first time to perform the second short-range wireless communication through the second link 320 longer than the second time to perform the first short-range wireless communication through the second link 320.

For another example, when the throughput of data transmitted/received through the first short-range wireless communication is greater than the throughput of data transmitted/received through the second short-range wireless communication, the electronic device 210 may configure the first time to perform the second short-range wireless communication through the second link 320 to be shorter than the second time to perform the first short-range wireless communication through the second link 320.

The electronic device 210 may configure the ratio of the first time and the second time based on the ratio of the throughput of data transmitted/received through the first short-range wireless communication and the throughput of data transmitted/received through the second short-range wireless communication.

According to an example, when the throughput of data transmitted/received through the first short-range wireless communication and the throughput of data transmitted/received through the second short-range wireless communication are less than or equal to the specified amount, the electronic device 210 may configure the same length of the first time for performing the second short-range wireless communication through the second link 320 and the length of the second time for performing the first short-range wireless communication through the second link 320.

According to an example, when the throughput of data transmitted/received through the first short-range wireless communication is less than the throughput of data transmitted/received through the second short-range wireless communication by a specified amount or more (or, exceeds), the electronic device 210 may configure the length of the first time for performing the second short-range wireless communication through the second link 320 to be longer than the length of the second time. For example, the length of the first time may be three times the length of the second time.

According to an example, when the throughput of data transmitted/received through the first short-range wireless communication is greater than the throughput of data transmitted/received through the second short-range wireless communication by a specified amount or more (or, exceeds), the electronic device 210 may configure the length of the first time for performing the second short-range wireless communication through the second link 320 to be shorter than the length of the second time for performing the first short-range wireless communication through the second link 320. The length of the second time may be three times the length of the first time.

According to an example, the electronic device 210 may configure the length of the first time and the second time based on a value (ratio) obtained by dividing the throughput of data transmitted/received through the second short-range wireless communication by the throughput of data transmitted/received through the first short-range wireless communication. The electronic device 210 may configure the ratio of the first time and the second time to substantially the same value (ratio) obtained by dividing the throughput of data transmitted/received through the second short-range wireless communication. For example, when the throughput of data to be transmitted/received through the second short-range wireless communication is three times the throughput of data to be transmitted/received through the first short-range wireless communication, the length of the first time may be three times the length of the second time.

For example, as the value (ratio) obtained by dividing the throughput of data transmitted/received through the second short-range wireless communication by the throughput of data transmitted/received through the first short-range wireless communication increases, the first time to perform the second short-range wireless communication through the second link 320 may increase and the second time to perform the first short-range wireless communication through the second link 320 may decrease.

For another example, as the value (ratio) obtained by dividing the throughput of data transmitted/received through the second short-range wireless communication by the throughput of data transmitted/received through the first short-range wireless communication decreases, the electronic device 210 may reduce the first time to perform the second short-range wireless communication through the second link 320 and increase the second time to perform the first short-range wireless communication through the second link 320.

When the throughput of data transmitted/received through the second short-range wireless communication increases, the electronic device 210 may increase the first time to perform the second short-range wireless communication through the second link 320 and reduce the second time to perform the first short-range wireless communication through the second link 320.

The electronic device 210 may perform scheduling of the first link 310 and the second link 320 to perform the first short-range wireless communication through the first link 310 during the first time when the second short-range wireless communication is performed through the second link 320. The electronic device 210 may perform scheduling of the first link 310 and the second short-range wireless communication through the first link 310 during the first time.

The electronic device 210 may perform scheduling of the first link 310 and the second link 320 to perform the second short-range wireless communication through the first link 310 during the second time when the first short-range wireless communication is performed through the second link 320. The electronic device 210 may perform scheduling of the first link 310 and the second link 320 to perform the second short-range wireless communication through the first link 310 and the first short-range wireless communication through the second link 320 during the second time.

The above-described example is an example in which the electronic device 210 performs scheduling of the first link 310 and the second link 320 based on a throughput. The electronic device 210 may perform scheduling of the first link 310 and the second link 320 in consideration of various parameters as well as throughput.

According to an example, the electronic device 210 may perform scheduling of the first link 310 and the second link 320 based on the features of the first service performed through the first short-range wireless communication and the features of the second service performed through the second short-range wireless communication. The processor 210 may perform the scheduling of the first link 310 and the second link 320 so that the first time length for performing the second short-range wireless communication through the second link 320 is longer than the second time length for performing the first short-range wireless communication through the second link 320, when the first service is a latency-insensitive service (e.g., a streaming service, a small data download service) and the second service is a latency-sensitive service (e.g., screen mirroring, which is a service that displays a screen that is displayed on a display of the electronic device 210 on a display of another electronic device (e.g., the second external electronic device 220-b), or display a screen that is displayed on a display of another electronic device (e.g., the second external electronic device 220-b) on a display of the electronic device 210, video calling, voice calling, or live broadcasting).

According to an example, the electronic device 210 may configure the priorities of the first short-range wireless communication and the second short-range wireless communication based on various parameters (e.g., the throughput of data transmitted and received through the first short-range wireless communication, the throughput of data transmitted and received through the second short-range wireless communication, and the second service features). The electronic device 210 may perform scheduling of the first link 310 and the second link 320 based on the priority of the first short-range wireless communication and the priority of the second short-range wireless communication.

According to an example, the priority of short-range wireless communication may be configured higher as the throughput is higher and the service through short-range wireless communication corresponds to a latency sensitive service.

In operation 850, the electronic device 210 may perform first short-range wireless communication and second short-range wireless communication based on scheduling.

The electronic device 210 may perform simultaneously receiving 531 data using first short-range wireless communication and receiving 532 data using second short-range wireless communication in a state where the channel of the second link 320 used to perform second short-range wireless communication is the same as the first channel of the second link 320 used to perform first short-range wireless communication. The electronic device 210 may not perform simultaneously transmitting data using first short-range wireless communication and transmitting data using second short-range wireless communication in a state where the channel of the second link 320 used to perform second short-range wireless communication is the same as the first channel of the second link 320 used to perform first short-range wireless communication, and data transmission using first short-range wireless communication and data transmission using second short-range wireless communication may be performed sequentially through a contention process with each other.

Based on scheduling, the electronic device 210 may control the communication circuitry 410 to perform first short-range wireless communication using the first link 310 and second short-range wireless communication using the second link 320 during the first time, and to perform first short-range wireless communication using the second link 320 and second short-range wireless communication using the first link 310 during the second time.

The electronic device 210 may control the communication circuitry 410 to perform first short-range wireless communication using the first link 310 and the second short-range wireless communication using the second link 320 during a first time based on scheduling. According to an example, when the electronic device 210, the first external electronic device 210-a, and/or the second external electronic device 210-b support a power saving mode, the electronic device 210 may control the communication circuitry 410 to transmit a signal (e.g., a null data frame with the PM bit configured to a first value (e.g., 1)) indicating the entry into the power saving mode through the second link 320 before the first time starts (or during a second time). As the first external electronic device 210-a receives the signal indicating the entry into the power saving mode through the second link 320, the data may not be transmitted to the electronic device 210 through the second link 320 during the first time, and the electronic device 210 may not perform first short-range wireless communication using the second link 320 during the first time. Accordingly, the electronic device 210 may perform second short-range wireless communication through the second link 320 during the first time. The electronic device 210 may control the communication circuitry 410 to transmit a signal (e.g., a null data frame with the PM bit configured to a first value (e.g., 1)) indicating the entry into the power saving mode through the first link 310 to the second external electronic device 210-b before the first time starts (or during the second time). As the second external electronic device 210-b receives a signal indicating the entry into the power saving mode through the first link 310, data may not be transmitted to the electronic device 210 through the first link 310 during a first time, and the electronic device 210 may not perform second short-range wireless communication using the first link 310 during a first time. Accordingly, the electronic device 210 may perform first short-range wireless communication through the first link 310 during a first time.

The electronic device 210 may control the communication circuitry 410 to perform first short-range wireless communication using the second link 320 and the second short-range wireless communication using the first link 310 during a second time based on scheduling. According to an example, when the electronic device 210, the first external electronic device 210-a, and/or the second external electronic device 210-b support a power saving mode, the electronic device 210 may control the communication circuitry 410 to transmit a signal (e.g., a null data frame with the PM bit configured to a first value (e.g., 1)) indicating the entry into the power saving mode through the second link 320 before the second time starts (or during a first time) to the second external electronic device 210-b). As the second external electronic device 210-b receives a signal indicating the entry into the power saving mode through the second link 320, the data may not be transmitted to the electronic device 210 through the second link 320 during a second time, and the electronic device 210 may not perform second short-range wireless communication using the second link 320 during a second time. Accordingly, the electronic device 210 may perform first short-range wireless communication through the second link 320 during a second time. The electronic device 210 may control the communication circuitry 410 to transmit a signal (e.g., a null data frame with the PM bit configured to a first value (e.g., 1)) indicating the entry into the power saving mode to the first external electronic device 210-a before the second time begins. As the first external electronic device 210-a receives a signal indicating the entry into the power saving mode through the first link 310, data may not be transmitted to the electronic device 210 through the first link 310 during a second time, and the electronic device 210 may not perform first short-range wireless communication using the first link 310 during a second time. Accordingly, the electronic device 210 may perform second short-range wireless communication through the first link 310 during a second time.

The electronic device 210 may control the communication circuitry 410 to perform first short-range wireless communication using the first link 310 and second short-range wireless communication using the second link 320 during a first time based on scheduling. According to an example, when the electronic device 210, the first external electronic device 210-a, and/or the second external electronic device 210-b support TID-to-mapping, the electronic device 210 may control the communication circuitry 410 to transmit a signal (e.g., no data to be transmitted/received through the second link 320) for deactivating the second link 320 to the first external electronic device 210-a before the first time starts (or during a second time). As the first external electronic device 210-a receives the signal for deactivating the second link 320 through the second link 320, data may not be transmitted to the electronic device 210 through the second link 320 during the first time, and the electronic device 210 may not perform first short-range wireless communication using the second link 320 during the first time. Accordingly, the electronic device 210 may perform second short-range wireless communication through the second link 320 during the first time. The electronic device 210 may control the communication circuitry 410 to transmit a signal for deactivating the first link 310 to the second external electronic device 210-b before the first time starts (or during a second time). As the second external electronic device 210-b receives the signal for deactivating the first link 310 through the first link 310, data may not be transmitted to the electronic device 210 through the first link 310 during the first time, and the electronic device 210 may not perform second short-range wireless communication using the first link 310 during the first time. Accordingly, the electronic device 210 may perform first short-range wireless communication through the first link 310 during the first time.

The electronic device 210 may control the communication circuitry 410 to perform first short-range wireless communication using the second link 320 and second short-range wireless communication using the first link 310 during a second time based on scheduling. According to an example, when the electronic device 210, the first external electronic device 210-a, and/or the second external electronic device 210-b support TID-to-mapping, the electronic device 210 may control the communication circuitry 410 to transmit a signal (e.g., no data to be transmitted/received through the second link 320) for deactivating the second link 320 to the second external electronic device 210-b before the second time starts (or during a first time). As the second external electronic device 210-b receives the signal for deactivating the second link 320 through the second link 320, the data may not be transmitted to the electronic device 210 through the second link 320 during a second time, and the electronic device 210 may not perform second short-range wireless communication using the second link 320 during a second time. Accordingly, the electronic device 210 may perform first short-range wireless communication through the second link 320 during the second time. The electronic device 210 may control the communication circuitry 410 to transmit a signal for deactivating the first link 310 to the first external electronic device 210-a before the second time starts (or during the first time). As the first external electronic device 210-a receives the signal for deactivating the first link 310 through the first link 310, data may not be transmitted to the electronic device 210 through the first link 310 during the second time, and the electronic device 210 may not perform first short-range wireless communication using the first link 310 during the second time. Accordingly, the electronic device 210 may perform second short-range wireless communication through the first link 310 during the second time.

The electronic device 210 may control the communication circuitry 410 to perform first short-range wireless communication using the first link 310 and the second short-range wireless communication using the second link 320 during a first time, and to perform first short-range wireless communication using the second link 310 during a second time based on scheduling. When the electronic device 210, the first external electronic device 220-a, and the second external electronic device 220-b support the target wake time (TWT) protocol, the electronic device 210 may transmit a parameter including a length of the first time, a start point of the first time, and/or an interval of the first time through the first link 310, to the first external electronic device 220-a through the first link 310, and a parameter including a length of the second time, a start point of the second time, and/or an interval of the second time through the second link 320 may be transmitted to the first external electronic device 220-a. The electronic device 210 and the first external electronic device 220-a may perform first short-range wireless communication through the first link 310 during the first time based on the length, start point, and/or interval of the first time, and may perform first short-range wireless communication through the second link 320 during the second time based on the length, start point and/or interval of the second time.

The electronic device 210 may transmit a parameter including the length of the first time, the start point of the first time, and/or the interval of the first time to the second external electronic device 220-b through the second link 320, and may transmit a parameter including the length of the second time, the start point of the second time, and/or the interval of the second time to the second external electronic device 220-b through the first link 310. The electronic device 210 and the second external electronic device 220-b may perform second short-range wireless communication through the second link 320 during the first time based on the length, start point, and/or interval of the second time, and may perform first short-range wireless communication through the first link 310 during the second time based on the length, start point and/or interval of the second time.

The electronic device 210 may identify (or monitor) the degree to which the first short-range wireless communication and/or the second short-range wireless communication actually occupies the first link 310 and the second link 320 while performing first short-range wireless communication and second short-range wireless communication based on scheduling, and may update (or modify) the scheduling based on the degree of actual occupation. According to an example, the electronic device 210 may compare the first time and the time to perform second short-range wireless communication using the second link 320 during the first time, and in the case that the time to perform second short-range wireless communication is less than the first time by a specified amount or more, the first time may be reduced and the second time to perform first short-range wireless communication using the second link 320 may be increased.

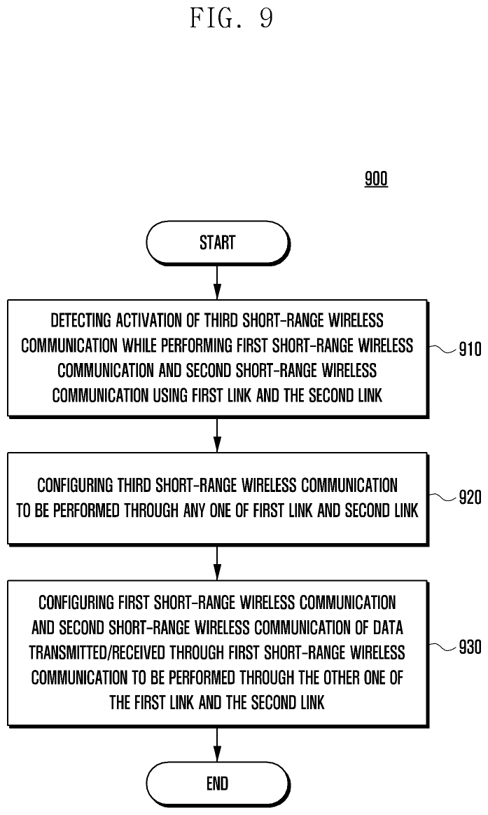

FIG. 9 is a flowchart 900 illustrating an operating method of an electronic device according to an embodiment.

In operation 910, the electronic device (e.g., the electronic device 210 of FIG. 4) may detect the activation of the third short-range wireless communication while performing first short-range wireless communication and second short-range wireless communication using the first link (e.g., the first link 310 of FIG. 3) and the second link (e.g., the second link 320 of FIG. 3).

The electronic device 210 may detect activation of the third short-range wireless communication while performing first short-range wireless communication and second short-range wireless communication. The third short-range wireless communication may include various short-range wireless communications that may be supported by the electronic device 210 and the third external electronic device 220-c. For example, the third short-range wireless communication may be either a mobile hotspot or a soft AP.

In operation 920, the electronic device 210 may configure the third short-range wireless communication to be performed through any one of the first link 310 and the second link 320.

In response to detecting the activation of the third short-range wireless communication, the electronic device 210 may configure the third short-range wireless communication to be performed through any one of the first link 310 and the second link 320. When the third short-range wireless communication is a short-range wireless communication that requires continuous transmission and/or reception of signals (e.g., the soft AP may have to transmit beacon signals at every specified time by the electronic device 210), the third short-range wireless communication may have to occupy one link alone or exclusively. Accordingly, the electronic device 210 may secure (or improve) the quality of service using the third short-range wireless communication by configuring the third short-range wireless communication to be performed through either the first link 310 or the second link 320.

According to an example, the electronic device 210 may compare the throughput of data to be transmitted/received through the third short-range wireless communication (e.g., the minimum throughput required by the service to be activated through the third short-range wireless communication) with the throughput of data to be transmitted/received through the first short-range wireless communication, and select a link to be allocated to the third short-range wireless communication based on the comparison result.

According to an example, the electronic device 210 may control the communication circuitry 410 to perform the third short-range wireless communication when the throughput of data to be transmitted/received (e.g., the minimum throughput required by the service to be activated through the third short-range wireless communication) is less than the throughput of data transmitted/received through the first short-range wireless communication and the throughput of data transmitted/received through the second short-range wireless communication.

According to an example, the electronic device 210 may control the communication circuitry 410 to perform the third short-range wireless communication using the higher frequency band when the throughput of data to be transmitted/received (e.g., the minimum throughput required by the service to be activated through the third short-range wireless communication) is greater than the throughput of data to be transmitted/received through the first short-range wireless communication and the throughput of data to/from the second short-range wireless communication.

In operation 930, the electronic device 210 may configure first short-range wireless communication and second short-range wireless communication to be performed through the other one of the first link 310 and the second link 320.

According to an example, the electronic device 210 may control the communication circuitry 410 to perform first short-range wireless communication and second short-range wireless communication using the higher frequency band when the throughput of data to be transmitted/received (e.g., the minimum throughput required by the service to be activated through the third short-range wireless communication) is less than the throughput of data to be transmitted/received through the first short-range wireless communication and the second link 320.

According to an example, the electronic device 210 may control the communication circuitry 410 to perform first short-range wireless communication and second short-range wireless communication using the lower frequency band when the throughput of data to be transmitted/received (e.g., the minimum throughput required by the service to be activated through the third short-range wireless communication) is greater than the throughput of data to be transmitted/received through the first short-range wireless communication and the second short-range wireless communication through the first link 310.

Based on the throughput of data transmitted/received through the first short-range wireless communication and the throughput of data transmitted/received through the second short-range wireless communication, the electronic device 210 may determine the length of the third time for the first short-range wireless communication to occupy the other link and the length of the fourth time for the second short-range wireless communication to occupy the other link. The electronic device 210 may perform scheduling of the other link based on the determined length.

According to an example, the electronic device 210 may perform scheduling of another link so that the length of the third time is longer than the length of the fourth time when the throughput of data transmitted/received through the first short-range wireless communication is greater than the throughput of data transmitted/received through the second short-range wireless communication.

According to an example, the electronic device 210 may perform scheduling of another link so that the length of the third time is shorter than the length of the fourth time when the throughput of data transmitted/received through the first short-range wireless communication is less than the throughput of data transmitted/received through the second short-range wireless communication.

The electronic device according to an example may include a communication circuitry 410 supporting a plurality of short-range wireless communications including first short-range wireless communication and second short-range wireless communication. The electronic device may include a memory 430 that stores at least one computer program. The electronic device may include at least one or more processors 420. When the electronic device is individually or collectively executed by the at least one processor 420, the electronic device may include an instruction for detecting the activation of the second short-range wireless communication while performing the first short-range wireless communication using the first link 310 corresponding to the first frequency band and the second link 320 corresponding to the second frequency band higher than the first frequency band. The instructions may cause the electronic device to perform scheduling of the first link 310 and the second link 320 based on a first throughput of data transmitted/received through the first short-range wireless communication and a second throughput of data to be transmitted/received through the second short-range wireless communication. The instructions may cause the electronic device to perform the first short-range wireless communication using the first link 310 and the second short-range wireless communication using the second link 320 during a first time 505 and 515, and perform the first short-range wireless communication using the second link 320 and the second short-range wireless communication using the first link 310 during a second time 506 and 516.

In the electronic device according to an example, the length of the first time 505 and 515 and the length of the second time 506 and 516 may be determined based on the first throughput and the second throughput.

In the electronic device according to an example, the ratio of the first time 505 and 515 and the second time 506 and 516 may be determined based on the ratio of the first throughput and the second throughput.

In the electronic device according to an example, the instructions may cause the electronic device to perform scheduling of the first link 310 and the second link 320 so that the length of the second time 506 and 516 is greater than the length of the first time 505 and 515, when executed individually or collectively by the at least one processor 420.

In the electronic device according to an example, the instructions may cause the electronic device to perform scheduling of the first link 310 and the second link 320 to change the length of the first time 505 and 515 and/or the length of the second time 506 and 516 when the first throughput and/or the second throughput change individually or collectively executed by the at least one processor 420.

In an electronic device according to an example, the instructions may cause the electronic device to perform scheduling of the first link 310 and the second link 320 so that the first latency of any one of the first short-range wireless communication and the second short-range wireless communication is lower than the second latency of the other, or the throughput of any one of the above is higher than the throughput of the other short-range wireless communication.

In an electronic device according to an example, the instructions may cause the electronic device to perform scheduling of the first link 310 and the second link 320 based on the features of the first service performed through the first short-range wireless communication and the features of the second service performed through the second short-range wireless communication, when executed individually or collectively by the at least one processor 420.

In the electronic device according to an example, the instructions may configure the third short-range wireless communication to be performed through any one of the first link 310 and the second link 320, and configure first short-range wireless communication and second short-range wireless communication to be performed through the other of the first link 310 and the second link 320, when executed individually or collectively by the at least one processor 420.

In an electronic device according to an example, the instructions may configure the electronic device to perform the third short-range wireless communication through the first throughput and/or the second throughput when the throughput of data transmitted/received through t the third short-range wireless communication is less than the first throughput and/or the second throughput, when executed individually or collectively by the at least one processor 420.

In the electronic device according to an embodiment, the third short-range wireless communication may include a soft AP.

In a computer-readable recording medium storing instructions to be performed by the electronic device processor 420 according to an example, the instructions may cause the electronic device to detect the activation of the second short-range wireless communication while performing the first short-range wireless communication using the first link 310 corresponding to the first frequency band and the second link 320 corresponding to the second frequency band higher than the first frequency band. The instructions may cause the electronic device to perform scheduling of the first link 310 and the second link 320 based on a first throughput of data transmitted/received through the first short-range wireless communication and a second throughput of data to be transmitted/received through the second short-range wireless communication. The instructions may cause the electronic device to perform the first short-range wireless communication using the first link 310 and the second short-range wireless communication using the second link 320 during a first time 505 and 515, and the first short-range wireless communication using the second link 320 and the second short-range wireless communication using the first link 310 during a second time 506 and 516.

In the recording medium according to an example, the length of the first time 505 and 515 and the length of the second time 506 and 516 may be determined based on the first throughput and the second throughput.

In the recording medium according to an example, the ratio of the first time 505 and 515 and the second time 506 and 516 may be determined based on the ratio of the first throughput and the second throughput.

In the recording medium according to an example, the instruction may cause the electronic device to perform scheduling of the first link 310 and the second link 320 so that the length of the second time 506 and 516 is greater than the length of the first time 505 and 515 when the first throughput is greater than the second throughput.

The scheduling of the first link 310 and the second link 320 may be performed so that the first latency of any one of the first short-range wireless communication and the second short-range wireless communication is lower than the second latency of the other, or the throughput of any one of the above is higher than the throughput of the other short-range wireless communication.

In a recording medium according to an example, the instruction may cause the electronic device to perform scheduling of the first link 310 and the second link 320 based on the features of the first service performed through the first short-range wireless communication and the features of the second service performed through the above second short-range wireless communication.

In the recording medium according to an example, the instruction may configure the electronic device to perform the third short-range wireless communication through any one of the first link 310 and the second link 320 based on detecting activation of the third short-range wireless communication. The instruction may configure the electronic device to perform first short-range wireless communication and second short-range wireless communication through the other of the first link 310 and the second link 320.

In an electronic device according to an example, the instruction may configure the electronic device to perform the third short-range wireless communication through the first link 310 when the throughput of data transmitted/received through the third short-range wireless communication is less than the first throughput and/or the second throughput.

The method of operating the electronic device according to an example may include detecting the activation of the second short-range wireless communication while performing the first short-range wireless communication using the first link 310 corresponding to the first frequency band and the second link 320 corresponding to the second frequency band higher than the first frequency band. The method of operating the electronic device may include performing scheduling of the first link 310 and the second link 320 based on a first throughput of data transmitted/received through the first short-range wireless communication and a second throughput of data to be transmitted/received through the second short-range wireless communication. The method of operating the electronic device may include performing the first short-range wireless communication using the first link 310 and the second short-range wireless communication using the second link 320 during a first time 505 and 515, and performing the first short-range wireless communication using the second link 310 during a second time 506 and 516.

In the method of operating the electronic device according to an example, the first time 505 and 515 and the second time 506 and 516 may be determined based on the first throughput and the second throughput.

The electronic device, according to an example, may include communication circuitry 410 supporting a plurality of short-range wireless communication protocols, including a first wireless communication protocol and a second wireless communication protocol. The electronic device may include a processor 420. The processor 420 may receive, through the communication circuitry, a request related to a second short-range wireless communication corresponding to the second short-range wireless communication protocol from a second external device different from the first external device while a first short-range wireless communication corresponding to the first short-range wireless communication protocol is being performed for the first external device through a first link corresponding to the first frequency band and a second link corresponding to the second frequency band. The processor 420 may, based at least in part on the request, be configured to control the communication circuitry to cause the second short-range wireless communication to be performed to the second external device through the second link while the first short-range wireless communication is not performed through the second link and is performed to the first external device through the first link, or to cause the second short-range wireless communication to be performed to the external device in the first time period and the second time period respectively through the second link and the first link while the first short-range wireless communication is performed through the first link in the first time period and through the second link in a second time period different from the first time period.

In an electronic device according to an example, the first short-range wireless communication protocol may correspond to one of a station (STA) interface, a peer-to-peer (P2P) interface, a neighbor awareness networking (NAN) interface, and a soft access point (AP) interface, and the second short-range wireless communication protocol may correspond to the other of the STA interface, the P2P interface, the NAN interface, and the soft AP interface.

In the electronic device according to an example, the second frequency band may be substantially different from the first frequency band.

In the electronic device according to an embodiment, the second frequency band may be substantially the same as the first frequency band. The second channel of the second link may be different from the first channel of the first link.

In an electronic device according to an example, the processor may be configured to control the communication circuitry, based at least on information associated with the first and second short-range wireless communications, so that a first latency corresponding to one of the first and second short-range wireless communications is lower than a second latency corresponding to the other of the first and second short-range wireless communications or a first throughput corresponding to the other short-range wireless communication is higher than a second throughput corresponding to the other short-range wireless communication while the first short-range wireless communication and the second short-range wireless communication are performed simultaneously.

In the electronic device according to an example, the information related to the first short-range wireless communication and the second short-range wireless communication may include at least one of a traffic usage of the first short-range wireless communication, a quality of service (QOS) corresponding to the first short-range wireless communication, a traffic demand of the second short-range wireless communication, or a QoS corresponding to the second short-range wireless communication.

In the electronic device according to an example, the processor may identify the second short-range wireless communication and the first short-range wireless communication as the one short-range wireless communication and the other short-range wireless communication, respectively. The processor may be configured to control the communication circuitry so that the first link and the second link are allocated to the first link, respectively, when the fourth latency corresponding to the second link is lower than the third throughput corresponding to the first link or higher than the third throughput corresponding to the second link.

In the electronic device according to an example, the processor may identify the second short-range wireless communication and the first short-range wireless communication as the one short-range wireless communication and the other short-range wireless communication, respectively. The processor may be configured to control the communication circuitry so that the first time period is longer than the second time period when the fourth latency corresponding to the second link is lower than the third latency corresponding to the first link or when the fourth throughput corresponding to the second link is higher than the third throughput corresponding to the first link.

In an electronic device according to an example, the processor may be configured to control the communication circuitry so that the first short-range wireless communication is performed through the first channel of the first link in the first time period and the second short-range wireless communication is performed through the first channel of the first link in the second time period.

In an electronic device according to an example, the processor may be configured to control the communication circuitry so that the first short-range wireless communication is performed through the first channel of the first link in the first time period, and the second short-range wireless communication is performed through the second channel of the first link in the second time period.

In an electronic device according to an example, the processor may control the communication circuitry so that, while the first and second short-range wireless communications are being performed simultaneously, the length of each of the first time period and the second time period is adjusted based at least in part on traffic information (traffic usage rate) of each communication of the first short-range wireless communication and the second short-range wireless communication for each link of the first link and the second link.

An electronic device, according to an example, may include a communication circuitry supporting a plurality of short-range wireless communication protocols, including a first wireless communication protocol and a second wireless communication protocol. The electronic device may include a processor. The processor may receive, through the communication circuitry, a request from a third external device related to a third short-range wireless communication while the first short-range wireless communication and the second short-range wireless communication corresponding to the first short-range wireless communication protocol and the second short-range wireless communication protocol, respectively, are being performed simultaneously for the first external device and the second external device through a first link corresponding to a first frequency band and a second link corresponding to a second frequency band. The processor may, based at least in part on the request, be configured to control the wireless communication circuitry to cause the second short-range wireless communication and the third short-range wireless communication to be performed through the second link for the second external device and the third external device, respectively, in the first time period and the second time period, which are different each other, while the first short-range wireless communication is not performed through the second link and is performed through the first link for the first external device.

In an electronic device according to an example, the processor may be configured to control the communication circuitry so that a first latency corresponding to the first short-range wireless communication is lower than a second latency corresponding to the second short-range wireless communication and a third latency corresponding to the third short-range wireless communication, or a first throughput corresponding to the first short-range wireless communication is higher than a second throughput corresponding to the second short-range wireless communication and a third throughput corresponding to the third short-range wireless communication while the first, second, and third short-range wireless communications are simultaneously performed.

In the electronic device according to an example, the processor may be configured to control the communication circuitry so that the second time period is longer than the third time period so that the second latency is lower than the third latency or the second throughput is higher than the third throughput.

1. An electronic device comprising:
a communication circuitry supporting a plurality of short-range wireless communications including a first short-range wireless communication and a second short-range wireless communication;
a memory storing instructions; and
at least one processor comprising processing circuitry, wherein
the instructions, when executed by the at least one processor individually and/or collectively, cause the electronic device to:
detect activation of the second short-range wireless communication while performing the first link corresponding to a first frequency band and a second link corresponding to a second frequency band higher than the first frequency band;
perform scheduling of the first link and the second link based on the first throughput of data transmitted/received through the first short-range wireless communication and the second throughput of data to be transmitted/received through the second short-range wireless communication; and
based on the scheduling, perform, during a first time, the first short-range wireless communication using the first link and the second short-range wireless communication using the second link, and perform, during a second time, the first short-range wireless communication using the second link and the second short-range wireless communication using the first link.

2. The electronic device of claim 1, wherein
the length of the first time and the length of the second time are determined based on the first throughput and the second throughput.

3. The electronic device of claim 1, wherein
the ratio of the first time and the second time is determined based on a ratio of the first throughput and the second throughput.

4. The electronic device of claim 1, wherein
the instructions, when executed individually and/or collectively by at least one processor, cause the electronic device to perform a scheduling of the first link and the second link so that the length of the second time is greater than the length of the first time in the case that the first throughput is greater than the second throughput.

5. The electronic device of claim 1, wherein
the instructions, when executed individually and/or collectively by at least one processor, cause the electronic device to perform a scheduling of the first link and the second link so that the length of the first time and/or the second time may be changed in the case that the first throughput and the second throughput are changed.

6. The electronic device of claim 1, wherein
the instructions, when executed individually and/or collectively by at least one processor, cause the electronic device to perform a scheduling of the first link and the second link so that the first latency of one of the first short-range wireless communication and the second short-range wireless communication is lower than the second latency of another short-range wireless communication, and/or the throughput of any one of the short-range wireless communications is higher than the throughput of the other short-range wireless communication.

7. The electronic device of claim 1, wherein
the instructions, when executed individually and/or collectively by at least one processor, cause the electronic device to perform a scheduling of the first link and the second link based on features of a first service performed through the first short-range wireless communication and features of a second service performed through the second short-range wireless communication.

8. The electronic device of claim 1, wherein
the instructions, when executed individually and/or collectively by at least one processor, cause the electronic device to be configured to:
perform the third short-range wireless communication based on detecting the activation of the third short range wireless communication through one of the first link and the second link; and
perform the first communication short-range wireless communication and the second short-range wireless communication through the other link of the first link and the second link.

9. The electronic device of claim 1, wherein
the instructions, when executed individually and/or collectively by at least one processor, cause the electronic device to be configured to perform the third short-range wireless communication through the first link in the case that the throughput of data transmitted/received through the third short-range wireless communication is less than the first throughput and/or the second throughput.

10. The electronic device of claim 1, wherein
the third short-range wireless communication comprises a soft AP.

11. An operating method of an electronic device supporting a first short-range wireless communication and a second short-range wireless communication, comprising:
detecting activation of the second short-range wireless communication while performing the first link corresponding to a first frequency band and a second link corresponding to a second frequency band higher than the first frequency band;
performing scheduling of the first link and the second link based on the first throughput of data transmitted/received through the first short-range wireless communication and the second throughput of data to be transmitted/received through the second short-range wireless communication; and
based on the scheduling, performing, during a first time, the first short-range wireless communication using the first link and the second short-range wireless communication using the second link, and perform, during a second time, the first short-range wireless communication using the second link and the second short-range wireless communication using the first link.

12. The operation method of claim 11, wherein the length of the first time and the length of the second time are determined based on the first throughput and the second throughput.

13. The operation method of claim 11, wherein the ratio of the first time and the second time is determined based on a ratio of the first throughput and the second throughput.

14. The operation method of claim 11, wherein the performing scheduling of the first link and the second link comprises:
performing a scheduling of the first link and the second link so that the length of the second time is greater than the length of the first time in the case that the first throughput is greater than the second throughput.

15. The operation method of claim 11, wherein the performing scheduling of the first link and the second link comprises:
performing a scheduling of the first link and the second link so that the length of the first time and/or the second time may be changed in the case that the first throughput and the second throughput are changed.

16. The electronic device of claim 15, wherein
the information related to the first short-range wireless communication and the second short-range wireless communication comprises at least one of a traffic usage of the first short-range wireless communication, a quality of service (QOS) corresponding to the first short-range wireless communication, a traffic demand of the second short-range wireless communication, or a QoS corresponding to the second short-range wireless communication.

17. The electronic device of claim 15, wherein
the processor is configured to:
identify the second short-range wireless communication and the first short-range wireless communication as the one short-range wireless communication and the other short-range wireless communication, respectively; and
control the communication circuitry so that the first link and the second link are allocated to the first short-range wireless communication and the second short-range wireless communication, respectively, when the fourth latency corresponding to the second link is lower than the third throughput corresponding to the first link or the fourth throughput corresponding to the second link is higher than the third throughput corresponding to the first link.

18. The electronic device of claim 15, wherein
the processor, which comprises one or more processors, is configured to:
identify the second short-range wireless communication and the first short-range wireless communication as the one short-range wireless communication and the other short-range wireless communication, respectively; and
control the communication circuitry so that the first time period is longer than the second time period when the fourth latency corresponding to the second link is lower than the third latency corresponding to the first link or when the fourth throughput corresponding to the second link is higher than the third throughput corresponding to the first link.

19. The electronic device of claim 11, wherein
the processor, which comprises one or more processors, is configured to control the communication circuitry so that the first short-range wireless communication is performed through the first channel of the first link in the first time period and the second short-range wireless communication is performed through the first channel of the first link in the second time period.

20. The electronic device of claim 11, wherein
the processor, which comprises one or more processors, is configured to control the communication circuitry so that the first short-range wireless communication is performed through the first channel of the first link in the first time period, and the second short-range wireless communication is performed through the second channel of the first link that is different from the first channel in the second time period.
